(19) United States
(12) Patent Application Publication
(10) Pub. No.: US 2015/0312331 A1
(43) Pub. Date: Oct. 29, 2015

(54) System and Method for Group Collaboration Using a Distributed Network File Repository

(71) Applicant: Shinkuro, Inc., Bethesda, MD (US)

(72) Inventors: Stephen D. Crocker, Bethesda, MD (US); Mark S. Feldman, Bethesda, MD (US); Robert G. Novas, Rockville, MD (US)

(73) Assignee: Shinkuro, Inc., Bethesda, MD (US)

(21) Appl. No.: 14/261,769

(22) Filed: Apr. 25, 2014

(51) Int. Cl. H04L 29/08; G06F 15/167

(52) U.S. Cl. CPC H04L 67/104; G06F 15/167

(57) ABSTRACT

A fast, efficient, secure, distributed, and multiplatform P2P-based collaboration solution may be used to communicate information (e.g., files, documents, etc.) between computing devices across logical, functional, organizational, and protection boundaries. The collaboration solution may include a first computing device configured to determine whether it is included the same collaboration group as a second computing device, and automatically establish a peer-to-peer based communication link to the second computing device in response to determining that they included in the same collaboration group. The first computing device may then receive a document list that identifies documents stored in a memory of the second computing device, and compare the received document list with a local document list to identify missing documents. The first computing device may send a document request message to the second computing device to request the identified missing documents, receive the requested documents, and store them its local memory.

### BACKGROUND

Increasingly, people are collaborating around the globe on a variety of media, including presentations, documents, videos, graphs and photographs. As a result, there has been an increase in group or online collaboration tools/systems that allow multiple users to remotely work on a single document or project. Many of these tools and system are hosted solutions that share information and updates between collaborating users via a centralized or Internet based web server. Such hosted solutions are advantageous because they allow users at different companies to collaborate and share information from behind firewalls without significant additional information technology (IT) support. Yet, existing hosted solutions are limited in a number of significant ways. For example, in such systems, the number of users that can simultaneously participate in an online collaboration effort is often limited by the resources, availability, and processing capabilities of the servers through which the users connect. Further, hosted solutions are not highly scalable solutions that are responsive to changes in the workload, usage, and/or traffic demands of the system. This is especially problematic in an online collaboration environment in which a large and variable number of users may be required connect to the same servers at the same time to participate in the online collaboration.

Another problem with existing hosted solutions is that they typically require that a participant's documents (and intellectual property) be stored in a third party's server and/or in an unencrypted format. This may provide a malicious user or application the opportunity to access or alter the documents without the knowledge or consent of the participating users. In addition, such hosted solutions are highly susceptible to losses because the documents are not stored on each user's computing device, and cannot be readily or efficiently downloaded or transferred to computers owned or controlled by the participating users. Further, these hosted solutions often create a single point of failure (e.g., the third party's server). If a server fails, a participant's documents and data may become inaccessible until that server is restored or replaced.

Online collaboration systems and solutions may also be implemented using peer-to peer (P2P) technologies that allow users to share documents and information without saving the information on a centralized or third-party server. These solutions typically establish direct connections between individual client systems and provide each client access to either the files or replicas of the files stored on other client systems. While these existing P2P solutions may overcome some of the limitations of hosted solutions, they are not suitable for use as part of a comprehensive and secure online collaboration solution. This is because existing P2P solutions are dependent on the availability of individual client systems, and are slow, inefficient, and unreliable. In addition, existing P2P solutions do not provide sufficient security measures for sharing documents. As such, a fast, efficient, and secure P2P-based collaboration solution that permits the sharing of documents and information across protection boundaries will be beneficial to corporations, organizations, and other consumers of such systems and solutions.

### SUMMARY

The various embodiments include methods of communicating documents in a communication system that includes a plurality of computing devices by determining in a processor of a first computing device whether the first computing device is associated with a first collaboration group, determining in the processor whether a second computing device is associated with the first collaboration group, establishing a peer-to-peer communication link between the first computing device and the second computing device in response to determining that the first and second computing devices are associated with the first collaboration group, generating in the processor a local cumulative hash list that identifies documents stored in a first collaboration memory of the first computing device, exchanging a hints list for an object list that identifies documents stored in a second collaboration memory of the second computing device that are possibly not stored in a first (local) collaboration memory of the first computing device, comparing the received objects list with the objects present in the first collaboration memory to determine that a document (or one or more of its constituent objects) is stored in the second collaboration memory and not stored in the first collaboration memory, sending a document request message to the second computing device to request the document (or its constituent objects), receiving the requested document (or its constituent objects) from the second computing device in response to sending the document request message, and storing the received document (or its constituent objects) in the first collaboration memory. In an embodiment, exchanging a hints list for an object list may include sending a hints list to the second computing device, and in response, receiving the object list from the second computing device.

In an embodiment, receiving the requested document from the second computing device may include receiving the requested document (or its constituent objects) from a dark storage device. In a further embodiment, receiving the requested document from the second computing device may include receiving a plurality of signed and encrypted objects from the second computing device, and storing the received document in the first collaboration memory may include storing the signed and encrypted objects in the first collaboration memory. In a further embodiment, the method may include receiving in the processor a second document request message from a third computing device, retrieving the signed and encrypted object from the first collaboration memory, and forwarding the retrieved signed and encrypted object to the third computing device. In a further embodiment, comparing the received hints list with the local cumulative hash list may include comparing a first hash of one or more object identifiers with a second hash of one or more object identifiers. In a further embodiment, comparing the received hints list with the local cumulative hash list includes comparing a most-cumulative hash value included in the received hints list with a second hash value included in the local cumulative hash list.

Further embodiments include a computing device having a first collaboration memory and a processor coupled to the first collaboration memory, the processor being configured with processor-executable instructions to perform operations that include determining whether the computing device is associated with a first collaboration group, determining whether a second computing device is associated with the first collaboration group, establishing a peer-to-peer communication link to the second computing device in response to determining that the computing device and the second computing device are both associated with the first collaboration group, generating a local cumulative hash list that identifies documents stored in the first collaboration memory, exchanging a hints list for an object list that identifies documents stored in a second collaboration memory of the second computing device that are possibly not stored in the collaboration memory of the first computing device, comparing the received objects list with the objects present in the local collaboration memory to determine that a document is stored in the second collaboration memory and not stored in the first collaboration memory, sending a document request message to the second computing device to request the identified document, receiving the requested document from the second computing device in response to sending the document request message, and storing the received document in the first collaboration memory.

In an embodiment, the processor may be configured with processor-executable instructions to perform operations such that receiving the requested document from the second computing device includes receiving the requested document from a dark storage device. In a further embodiment, the processor may be configured with processor-executable instructions to perform operations such that receiving the requested document from the second computing device includes receiving a plurality of signed and encrypted objects from the second computing device, and storing the received document in the first collaboration memory includes storing the signed and encrypted objects in the first collaboration memory.

In a further embodiment, the processor may be configured with processor-executable instructions to perform operations that further include receiving a second document request message from a third computing device, retrieving the signed and encrypted object from the first collaboration memory, and forwarding the retrieved signed and encrypted object to the third computing device. In a further embodiment, the processor may be configured with processor-executable instructions to perform operations such that comparing the received hints list with the local cumulative hash list includes comparing a first hash of one or more object identifiers with a second hash of one or more object identifiers. In a further embodiment, the processor may be configured with processor-executable instructions to perform operations such that comparing the received hints list with the local cumulative hash list includes comparing a most-cumulative hash value included in the received hints list with a second hash value included in the local cumulative hash list.

Further embodiments include a computing device having means for determining whether the computing device is associated with a first collaboration group, means for determining in the processor whether a second computing device is associated with the first collaboration group, means for establishing a peer-to-peer communication link to the second computing device in response to determining that the computing device and the second computing device are both associated with the first collaboration group, means for generating a local cumulative hash list that identifies documents stored in a collaboration memory of the first computing device, means for exchanging a hints list for an object list that identifies documents stored in a second collaboration memory of the second computing device that are possibly not stored in the collaboration memory of the first computing device, means for comparing the received objects list with the objects present in the local collaboration memory to determine that a document is stored in the second collaboration memory and not stored in the first collaboration memory, means for sending a document request message to the second computing device to request the identified document, means for receiving the requested document from the second computing device in response to sending the document request message, and means for storing the received document in the first collaboration memory.

In an embodiment, means for receiving the requested document from the second computing device includes means for receiving the requested document from a dark storage device. In a further embodiment, means for receiving the requested document from the second computing device includes means for receiving a plurality of signed and encrypted objects from the second computing device, and means for storing the received document in the first collaboration memory includes means for storing the signed and encrypted objects in the first collaboration memory. In a further embodiment, the computing device includes means for receiving in the processor a second document request message from a third computing device, means for retrieving the signed and encrypted object from the first collaboration memory, and means for forwarding the retrieved signed and encrypted object to the third computing device. In a further embodiment, means for comparing the received hints list with the local cumulative hash list includes means for comparing a first hash of one or more object identifiers with a second hash of one or more object identifiers. In a further embodiment, means for comparing the received hints list with the local cumulative hash list includes means for comparing a most-cumulative hash value included in the received hints list with a second hash value included in the local cumulative hash list.

Further embodiments include a non-transitory computer readable storage medium having stored thereon processor-executable software instructions configured to cause a processor to perform operations for communicating documents in a communication system that includes a plurality of computing devices, the operations including determining whether the computing device is associated with a first collaboration group, determining whether a second computing device is associated with the first collaboration group, establishing a peer-to-peer communication link between the computing device and the second computing device in response to determining that the computing device and the second computing device are both associated with the first collaboration group, generating a local cumulative hash list that identifies documents stored in a first collaboration memory of the computing device, exchanging a hints list for an object list that identifies documents stored in a second collaboration memory of the second computing device that are possibly not stored in the collaboration memory of the first computing device, comparing the received objects list with the objects present in the local collaboration memory to determine that a document is stored in the second collaboration memory and not stored in the first collaboration memory, sending a document request message to the second computing device to request the identified document, receiving the requested document from the second computing device in response to sending the document request message, and storing the received document in the first collaboration memory.

In an embodiment, the stored processor-executable software instructions may be configured to cause a processor to perform operations such that receiving the requested document from the second computing device includes receiving the requested document from a dark storage device. In a further embodiment, the stored processor-executable software instructions may be configured to cause a processor to perform operations such that receiving the requested document from the second computing device includes receiving a plurality of signed and encrypted objects from the second computing device, and storing the received document in the first collaboration memory includes storing the signed and encrypted objects in the first collaboration memory.

In a further embodiment, the stored processor-executable software instructions may be configured to cause a processor to perform operations further including receiving in the processor a second document request message from a third computing device, retrieving the signed and encrypted object from the first collaboration memory, and forwarding the retrieved signed and encrypted object to the third computing device. In a further embodiment, the stored processor-executable software instructions may be configured to cause a processor to perform operations such that comparing the received hints list with the local cumulative hash list includes comparing a first hash of one or more object identifiers with a second hash of one or more object identifiers. In a further embodiment, the stored processor-executable software instructions may be configured to cause a processor to perform operations such that comparing the received hints list with the local cumulative hash list includes comparing a most-cumulative hash value included in the received hints list with a second hash value included in the local cumulative hash list.

Further embodiments may include methods of communicating documents in a communication system that includes a plurality of computing devices by exchanging a hints list for an object list that identifies documents (or objects) stored in a second collaboration memory of the second computing device that are possibly not stored in a first collaboration memory of the first computing device and which identifies a state of the second collaboration memory at various randomly chosen points in an ordered list of objects, comparing the object list with the objects present in the first collaboration memory to determine that a document is stored in the second collaboration memory and not stored in the first collaboration memory, sending a document (or object) request message to the second computing device to request the document (or object), receiving the requested document (or object) from the second computing device in response to sending the document request message; and storing the received document (or object) in the first collaboration memory.

In an embodiment, receiving the requested document from the second computing device may include receiving the requested document from a dark storage device. In a further embodiment, receiving the requested document from the second computing device may include receiving a plurality of signed and encrypted objects from the second computing device. In a further embodiment, storing the received document in the first collaboration memory may include storing the signed and encrypted objects in the first collaboration memory. In a further embodiment, comparing the object list with the objects present in the first collaboration memory may include comparing a first hash of one or more object identifiers with a second hash of one or more object identifiers. In a further embodiment, comparing the object list with the objects present in the first collaboration memory may include comparing a most-cumulative hash value included in the object list with a second hash value.

Further embodiments may include a computing device that includes a processor configured with processor-executable instructions to perform various operations corresponding to the methods discussed above. Further embodiments may include a computing device that includes various means for performing functions corresponding to the method operations discussed above. Further embodiments may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram illustrating various components and communication links in an example data replication system that is suitable for communicating documents and other information in accordance with the various embodiments.

FIG. 2A is a call flow diagram illustrating components and information flows in a data replication system configured to perform an embodiment registration method.

FIG. 2B is a process flow diagram illustrating an embodiment registration method for registering users to access the file replication system.

FIGS. 2C and 2D are process flow diagrams illustrating embodiment methods of publishing information to a DNS module for a user and/or client device as part of an embodiment registration operation.

FIG. 2E is a block diagram illustrating example information that may be stored in a DNS module for the user and/or client device as part of an embodiment registration operation.

FIG. 3A is a call flow diagram illustrating components and information flows in a data replication system configured to perform an embodiment login method for providing users access to use the file replication system.

FIG. 3B is a process flow diagram illustrating an embodiment login method of providing users access to use the file replication system.

FIGS. 3C and 3D are process flow diagrams illustrating embodiment methods of publishing information to a DNS module for a user and/or client device as part of providing the user/client access to use the file replication system.

FIGS. 3E and 3F are block diagrams illustrating example information that may be stored in a DNS module for the user and/or client device as part of providing the user/client access to use the file replication system.

FIG. 4A is a call flow diagram illustrating various components and information flows in a data replication system configured to perform an embodiment method for creating collaboration groups.

FIG. 4B is a process flow diagram illustrating an embodiment method for creating collaboration groups in the file replication system.

FIGS. 5A and 5B are call flow diagrams that illustrate components and information flows in a data replication system configured to add a user or device to a collaboration group in accordance with an embodiment.

FIGS. 6A through 6E are process flow diagrams that illustrate an embodiment method of adding a user or device to a collaboration group.

FIG. 7A is a call flow diagram illustrating various components and information flows in a data replication system configured to synchronize documents in accordance with an embodiment.

FIG. 7B is process flow diagram illustrates an embodiment method of sharing a document with another member of a group.

FIG. 7C is process flow diagram illustrates an embodiment method of receiving a document from another member of a group.

FIG. 8 is a process flow diagram illustrating a method of establishing communication links and synchronizing documents based on group membership in accordance with an embodiment.

FIG. 9A is a process flow diagram illustrating a method of synchronizing documents in accordance with an embodiment.

FIG. 9B is a process flow diagram illustrating a method of synchronizing documents in accordance with another embodiment.

FIG. 10 is a component block diagram of a mobile device suitable for use in an embodiment.

FIG. 11 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “computing device” is used generically herein to refer to any one or all of servers, personal computers, laptop computers, tablet computers, smartbooks, ultrabooks, palm-top computers, wireless electronic mail receivers, multimedia Internet enabled cellular telephones, and similar electronic devices that include a memory, a programmable processor suitable for executing software application programs, and network communications circuitry suitable for sending and receiving information.

The terms “peer-to-peer network” and “P2P network” are used interchangeably herein to refer to any decentralized or distributed network in which individual nodes in the network can act as both suppliers and consumers of information and resources. While some embodiments refer to peer-to-peer networks that make use of Internet protocol (IP), transmission control protocol (TCP), and hypertext transfer protocol (HTTP) messaging, such references are intended merely to serve as examples, and not to limit the scope of the claims to any particular networking technology unless these terms are expressly recited in the claims.

As used in this application, the terms “component,” “module,” “system,” “resolver,” and the like are intended to include a computer-related entity, such as hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computing device. By way of illustration, both an application running on a computing device and the computing device may be referred to as a component. One or more components may reside within a process and/or thread of execution and a component may be localized on one processor or core and/or distributed between two or more processors or cores. These components may execute from various non-transitory computer readable media having various instructions and/or data structures stored thereon. Components may communicate by way of communication messages, local and/or remote processes, function or procedure calls, electronic signals, data packets, memory read/writes, and other known network, computer, processor, and/or process related communication methodologies.

In overview, the various embodiments include components (e.g., computing devices, software applications, etc.) configured to provide a fast, efficient, secure, distributed, de-centralized and multiplatform P2P-based collaboration solution that permits the sharing of information (e.g., files, documents, etc.) between computing devices across logical, functional, organizational, and protection boundaries. The P2P-based collaboration solution may be provided via, or include, a data replication system. The data replication system may be implemented in one or more computing devices.

In various embodiments, the data replication system may include computing devices that are configured to use existing transport protocols and technologies to establish highly secure P2P-based data collection and/or distribution networks.

In various embodiments, the data replication system may include computing devices that are configured to intelligently establish, join, or update one or more communication or collaboration groups. Each computing device in a collaboration group may be configured to coordinate, synchronize, and/or replicate documents across the computing devices in that group. Maintenance of the membership of the groups may be done by the computing devices making up the groups.

In an embodiment, the data replication system may include computing devices configured to implement autonomous routines that enable the computing devices to self-organize to form ad hoc P2P-based communication networks based on the collaboration groups to which the devices belong. The computing devices may also be configured to use the collaboration groups to self-administer priorities and/or access rights for viewing, receiving, storing, and/or accessing documents. As such, the collaboration groups may provide the computing devices and their users with fine grained controls over the precise documents and information that is shared with other computing devices in the network, system, or group.

In various embodiments, the data replication system may include multiple heterogeneous computing devices configured to coordinate, synchronize, and/or replicate documents quickly, efficiently, and irrespective of the locations, platforms, or hardware/software configurations of the individual computing devices.

Each computing device may include a local collaboration memory and a local working memory. The computing devices may share documents by transferring the documents (or their associated or constituent objects) from the working memory to the collaboration memory, and synchronizing the contents of the collaboration memories among all member computing devices of the group. In an embodiment, a document may include a handle object, a naming object, a file object, and an atom object. In various embodiments, transferring a document may include transferring any or all of the handle, naming, file, and atom objects that constitute the document.

Each computing device may be configured to store each document (e.g., file, etc.) in its local collaboration memory as one or more objects. The objects may include or encapsulate the content of the stored document, as well as its metadata. Each object may be associated with an object identifier (i.e., Object ID) that uniquely identifies that object. The metadata may include information that is suitable for use in identifying other users or devices that store the requested document, its object identifiers, heritage, modification history, usage history, communication history, access rights, timestamps, and/or other similar information. The computing devices may use such metadata to identify various characteristics of the document, its history, access rights, etc.

In addition, each computing device may be configured to generate and/or store an object ID list, a cumulative hash list, and a hints list. The object ID list may be an ordered list of the Object IDs of each object stored in the local collaboration memory of each member device. The cumulative hash list may be a list of hash values, and include a record for each record included in the object ID list (i.e., the cumulative hash list may be the same size as the object ID list). That is, the cumulative hash list may include a hash value for each object ID value in the object ID list. Each of the hash values may be computed as a hash of its corresponding object ID in the object ID list (i.e., having the same index or location in the list) and all preceding object IDs in the object ID list. For example, the first entry in the cumulative hash list may be a hash of the first entry in the object ID list; the second entry in the cumulative hash list may be a hash of the first and second entries in the object ID list; the third entry in the cumulative hash list may be a hash of the first, second, and third entries in the object ID list; and so on. The hints list may include a select subset of the hash values included in the cumulative hash list, including the most cumulative hash value (i.e., last value in the hash list).

As discussed above, the data replication system may include multiple computing devices configured to coordinate, synchronize, and/or replicate documents by synchronizing the contents of their respective collaboration memories. In an embodiment, the computing devices may be configured to synchronize the contents of their respective collaboration memories by using a hints list (or select list of hash values). For example, each computing device in a group may be configured to receive a hints list from another computing devices that is also a member of that group, compare the received hints list with a local cumulative hash list for the same group to identify discrepancies between the lists, use the identified discrepancies to identify objects that are shared with the group but not stored in a local collaboration memory, request and receive the missing objects/documents from the other computing device, and store the received objects/documents in its local collaboration memory. The computing devices may perform these operations repeatedly until every computing device in the group stores the same objects or documents as every other computing device in that group.

As a further example, the data replication system may include two computing devices that are members of the same group. The first computing device may receive a hints list that includes at least one hash value that may be used to identify all of the documents that are stored in the collaboration memory of the second computing device. The first computing device may compare the hints list with a local list (e.g., cumulative hash list) that identifies all of the documents that are stored in the local collaboration memory of the first computing device. Comparing the hints list to the local lists may include identifying the last matching hash values in the lists, and using this information to identify discrepancies between the two lists and/or to identify the objects (and thus documents) that are not included in both lists. If the last matching hash value is the last value in each list, then the two lists match exactly and the two computing devices are said to be “in sync.” The first computing device may send the second computing device a message indicating that the two computing devices are synchronized.

Otherwise, the first computing device may use a result of this comparison to identify a list of objects that are stored in the local collaboration memory of the first computing device (and thus available to be shared with the group) that may or may not be in the local collaboration memory of the second computing device. The first computing device may then send this list to the second computing device. The second computing device may receive this list and identify any objects that are on the list (and hence present in the local collaboration memory of the first computing device) but that are not in the local collaboration memory of the second computing device. The second computing device may then send the first computing device an object request message for each object that is not in the local collaboration memory of the second computing device. Upon receiving each object request, the first computing device may then send the requested object to the second computing device. The second computing device may receive and store each object it receives in its local collaboration memory.

By using hash lists and/or hashing techniques, the various embodiments may quickly and efficiently identify missing documents, share these documents, and significantly reduce the amount of information that is exchanged to determine the synchronization state of the various connected computing devices. The various embodiments thus reduce amount of information that is communicated between the computing devices in the steady state.

As is discussed above, the first computing device may use hints to identify missing documents and request or pull the missing documents from the second computing device. Alternatively, in another embodiment, additional efficiency may be gained by pushing documents to the local collaboration memory of the second computing device. For example, when a document is created on the first computing device, then that document may be pushed to any and all computing devices to which it is currently connected. In this embodiment, the first computing device may push the object IDs of the objects that make up the newly created document, and the second computing device may pull the objects by requesting each object by its object ID from the first computing device. In this manner, the connected devices receive new information quickly and efficiently. Devices that were disconnected at the time the new document was created would still receive the new document using the pull technique discussed above.

In various embodiments, the computing devices may be configured to perform any or all of the above mentioned operations periodically, continuously, near-continuously, repeatedly, and/or until every computing device that is a member of a group stores the same documents (or references/links to the documents) as every other computing device that is a member of that group. In addition, the computing devices may be configured to synchronize their collaboration memories in response to receiving a poll activation message or detecting a condition or event. For example, the first computing device may be configured to send a notification message to a second computing device in response to determining that it has been added to the same group as the second computing device. In response to receiving this notification message, the second computing device may send a hints list to the first computing device. The first computing device may receive and use this hints lint to identify and request missing documents from the second computing device.

In various embodiments, the data replication system may include computing devices configured to encode and sign the objects when they are created, and then use one or more additional cryptography techniques to provide an additional layer of security for the communication/transport of the objects between the computing devices. As such, the data replication system may provide multiple levels of security, encryption, and/or encoding for the information and communications.

In various embodiments, the data replication system may include computing devices configured to use strong or formidable authentication techniques to encrypt and sign the objects when they are created. The computing devices may encrypt and sign the objects so as to allow the other computing devices to retain the objects and object signatures, even after they are decrypted, decoded, and/or rendered in a receiving device.

By allowing the computing devices to retain the objects and their signatures, any computing device in a group may share a received document with other computing device in its group as if it were the computing device from which the document originated. This allows the computing devices to share documents irrespective of the availability of any specific computing device (e.g., the originating computing device) in the group and guarantee the integrity of the documents and/or the identities of the originators/contributors of the document.

In the various embodiments, the computing devices may be configured so that any computing device in a group that receives a document request message and stores a requested document may automatically send the requested documents (or its corresponding objects) to the requesting computing device. In an embodiment, sending the requested documents to the requesting computing device may include retrieving signed and encrypted objects of the requested documents from memory, and sending the retrieved objects to the requesting computing device without decoding, decrypting or authenticating the objects.

In an embodiment, the data replication system may be configured so that the computing devices store documents in memory in an encrypted format, and de-encrypt the documents each time they are rendered. The computing device may de-encrypt the documents without using a centralized authentication server or service. As such, the data replication system may reduce or prevent the likelihood of access or use of the stored documents by an unauthorized user or software application.

In the various embodiments, the data replication systems may include autonomous routines that enable the computing devices to self-group themselves and/or self-administer priorities for accessing documents. In an embodiment, the priorities or access rights be determined/established based on the collaboration groups to which the devices belong.

In the various embodiments, the data replication systems may be configured so that each computing device may communicate with every other computing device that is available (e.g., powered, connected, online, etc.) and in the same collaboration group. The communications may be accomplished using existing HTTP/TCP infrastructures and technologies and via direct, ad hoc, local, short-range radio (e.g., Bluetooth®, WiFi, Zigbee®, etc.) and/or peer-to-peer connections. For example, the computing devices may be configured to automatically establish P2P-based communication links to other computing devices in the same collaboration group, and use these links to communicate objects via HTTP/TCP).

In various embodiments, the data replication systems may be configured so that the computing device may communicate via the Internet, WAN, LAN or other similar networks. In an embodiment, the computing devices may be configured to automatically select the best available communication technology to accomplish the communication (e.g., based on the physical proximity of the devices, the speed of the available communication links, the available bandwidth, etc.). For example, a first computing device may be configured to automatically terminate an Ethernet-based communication link to a second computing device and establish a short-range radio communication link to the second computing device in response to detecting that it is in close physical proximity to the second computing device.

Various embodiments may include a relay device configured to receive and forward communication messages between two or more computing devices in a group. The relay device may establish communication links between computing devices that are behind firewalls, and facilitate the communications between the connected devices. Each relay device may include a unique name that advertized via a domain name system (DNS) component.

In the various embodiments, the computing devices may be assigned to specific relays, and the relay assignments may be stored or maintained by a DNS component. A computing device may initiate communications with a destination device by performing a DNS lookup to identify its assigned relay (or a relay device that is assigned to the destination device). The computing device may request to establish a communication link to the identified relay. The relay device may receive the request, perform a DNS look up to verify that the sending device is associated with the relay device, and establish a communication link to the computing device (and/or publish the computing device's presence). The relay device may also perform a DNS lookup to determine the logical location of the destination device. The relay device may then establish a communication link to the destination device, and relay/forward all communications received from the computing device to the destination device.

Various embodiments may include a dark storage device that is configured to receive and store objects in an encrypted format. The dark storage device may store these objects without storing (or ever obtaining) their corresponding decryption keys. That is, the dark storage device may store the objects so that the objects cannot be decrypted locally in the dark storage device itself (e.g., by a malicious application) or in any unauthorized device that obtains the objects. This allows dark storage device to operate as a secure store-and-forward device that forwards the stored encrypted objects to authorized computing devices that store the proper decryption keys. The computing devices may be configured to request documents from the dark storage device when the other peer devices that store the requested document are not power, online, or available. As such, the dark storage device may allow a computing device in a P2P network to receive any or all of the documents that are shared with its group, without a centralized server and irrespective of whether other peer devices are connected to the P2P network.

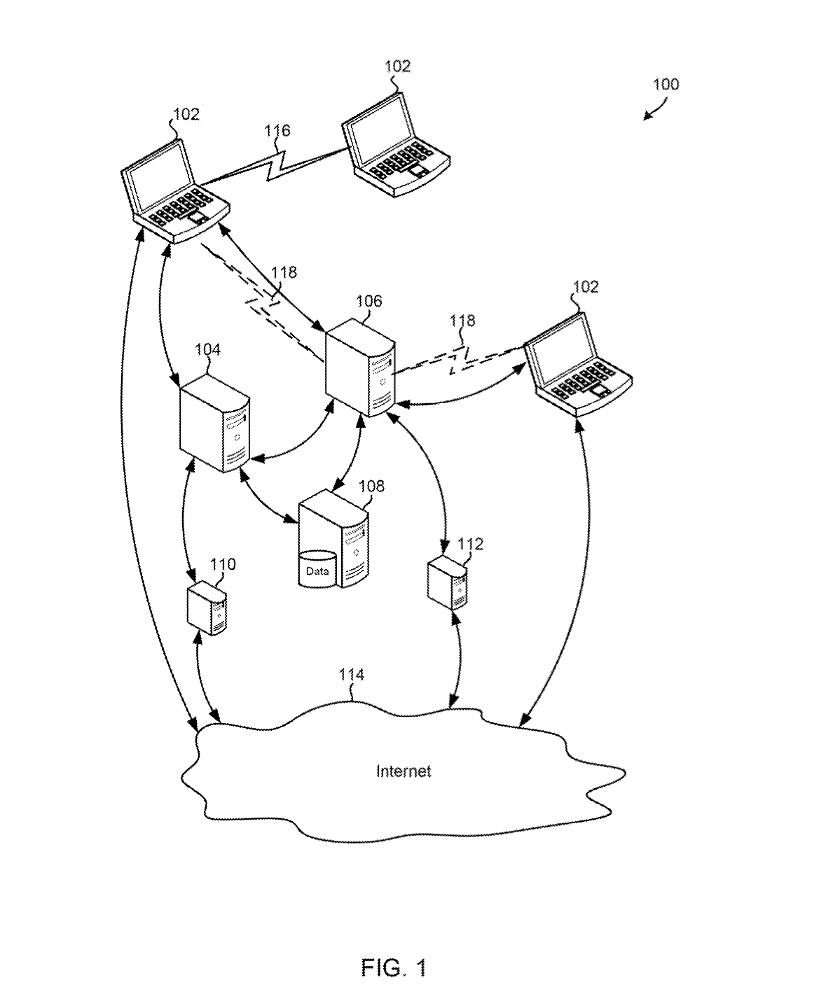

FIG. 1 illustrates an example communication system 100 that is suitable for use in communicating documents via P2P-based communication links in accordance with the various embodiments. In the example illustrated in FIG. 1, the communication system 100 includes a plurality of computing devices 102, a management server 104, a relay device 106, a dark storage device 108, a management DNS device 110, and a relay DNS device 112, any or all of which may be coupled to the Internet 114. The computing devices 102 may communicate via direct P2P-based communication links 116 or indirect P2P-based communication links 118 (by definition, one end of an indirect link must be a relay).

The direct P2P-based communication links 116 may be established via Ethernet, LAN, or short-range radio links (e.g., Bluetooth®, WiFi, Zigbee®, etc.). The indirect P2P-based communication links 118 may be established via the relay device 106, Internet 114, and other related components/network. For example, computing devices 102 that are behind firewalls may communicate with the relay device 106 via the internet 114, and the relay device 106 may forward or relay these communications between the computing devices 102.

The computing devices 102 may communicate with the management server 104 to register and publish their presence in the communication system 100. For example, a computing device 102 may send the management server 104 various objects, object signatures, key pair values, system identifiers, user identification information (e.g., email address, etc.), password information, registration confirmation information, and/or other similar information. In response, the management server 104 may register the computing device 102, update its registration status (e.g., pending, active, etc.), and/or assign it to a relay device 106. The management server 104 may also send the relay assignments and other related information to the relay DNS device 112 for storage and publication.

The relay DNS device 112 may be configured to store the relay assignments of the computing devices 102 and to advertize the unique name or identifier the relay device 106. A computing device 102 may communicate with the relay DNS device 112 (e.g., via the Internet 114) to identify its assigned relay device 106. Likewise, the relay device 106 may communicate with the relay DNS device 112 to verify relay assignments and/or to locate or identify a computing device 102.

The dark storage device 108 may be a secure store-and-forward device that is configured to store documents and information as encrypted objects. The computing devices 102 may be configured to communicate with the dark storage device 108 to request and receive the encrypted objects. The computing devices 102 may then use a locally stored decryption key to decode the received objects.

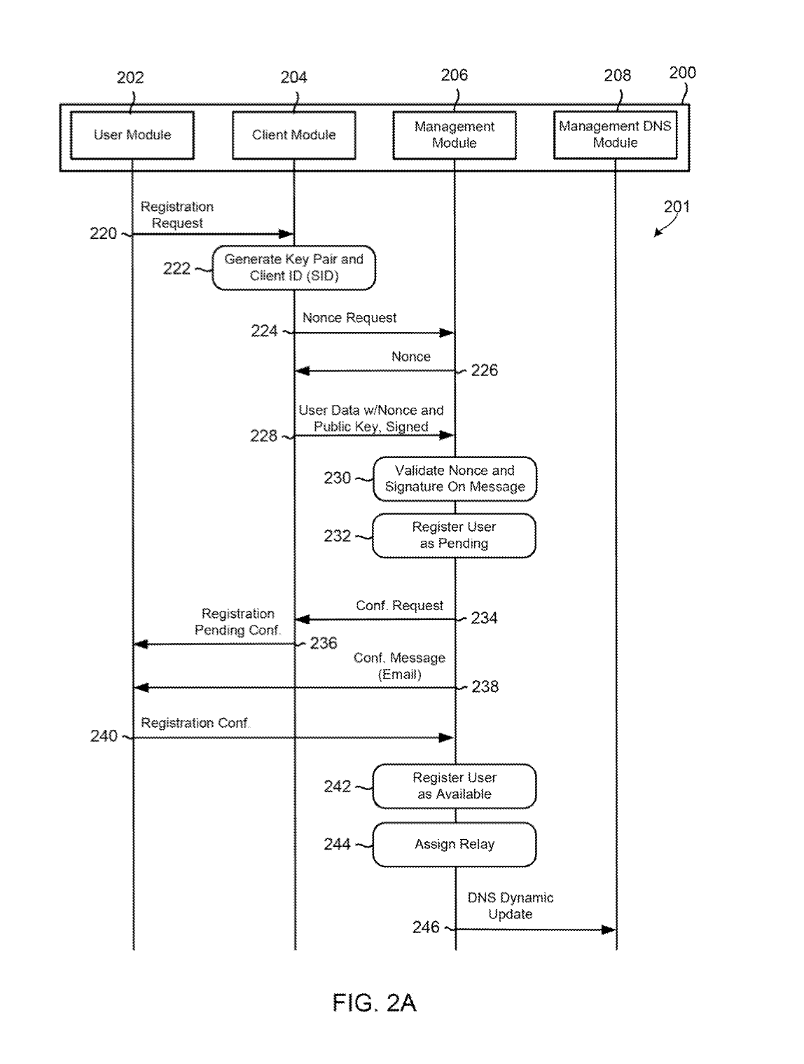

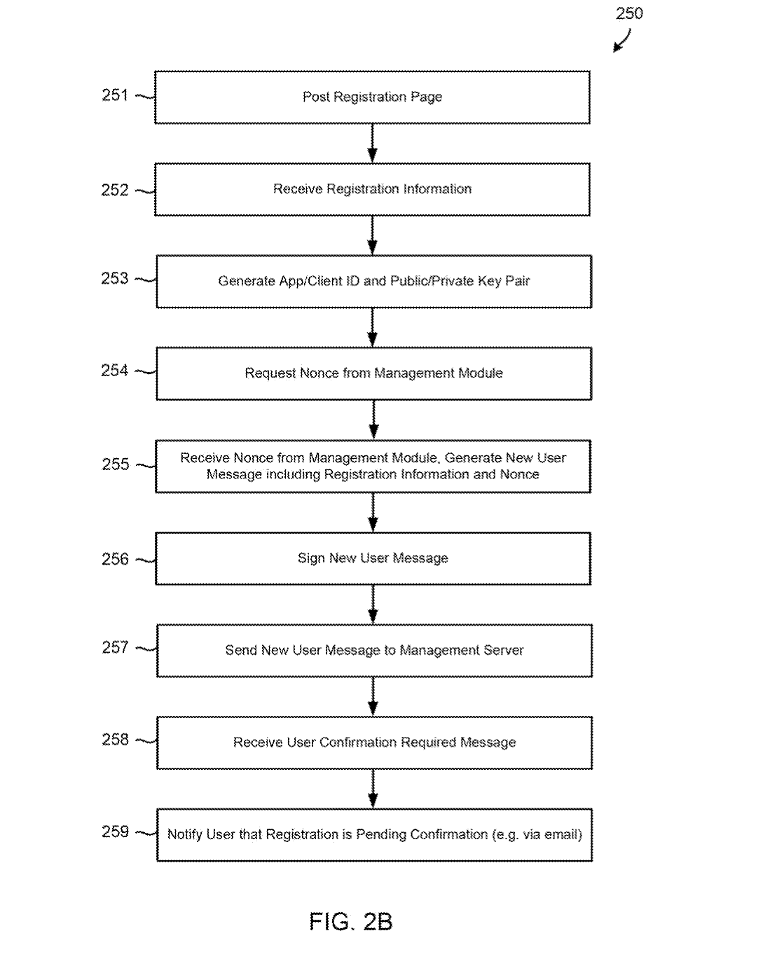

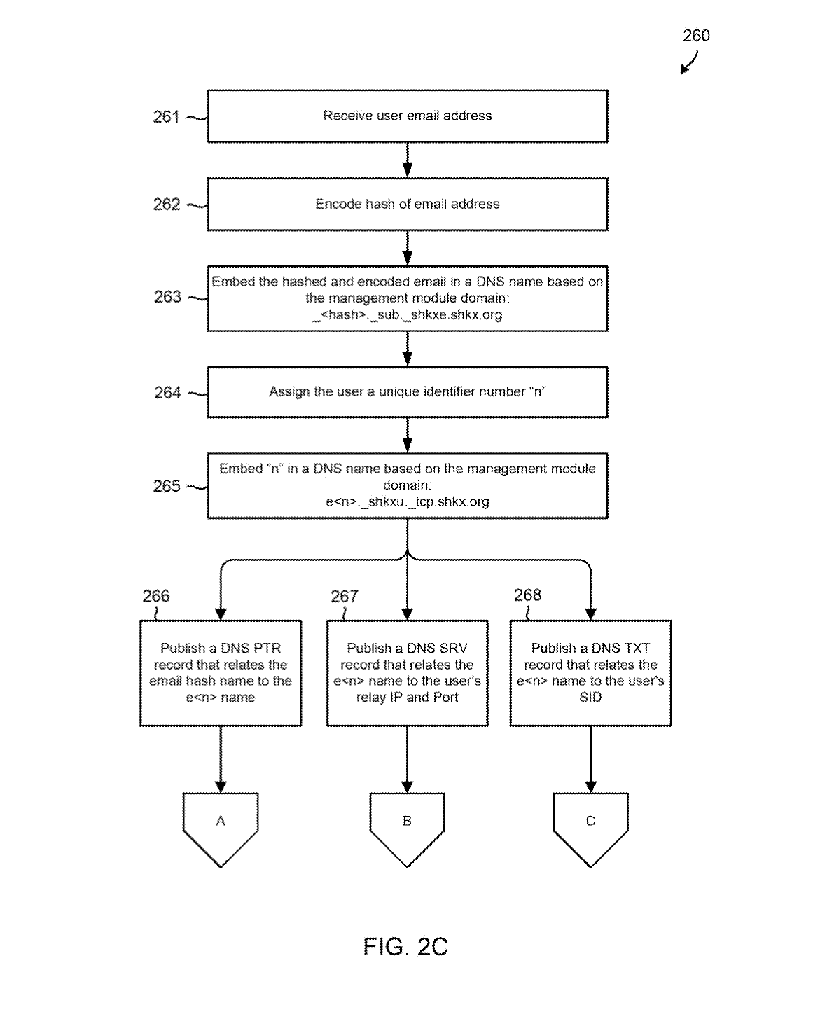

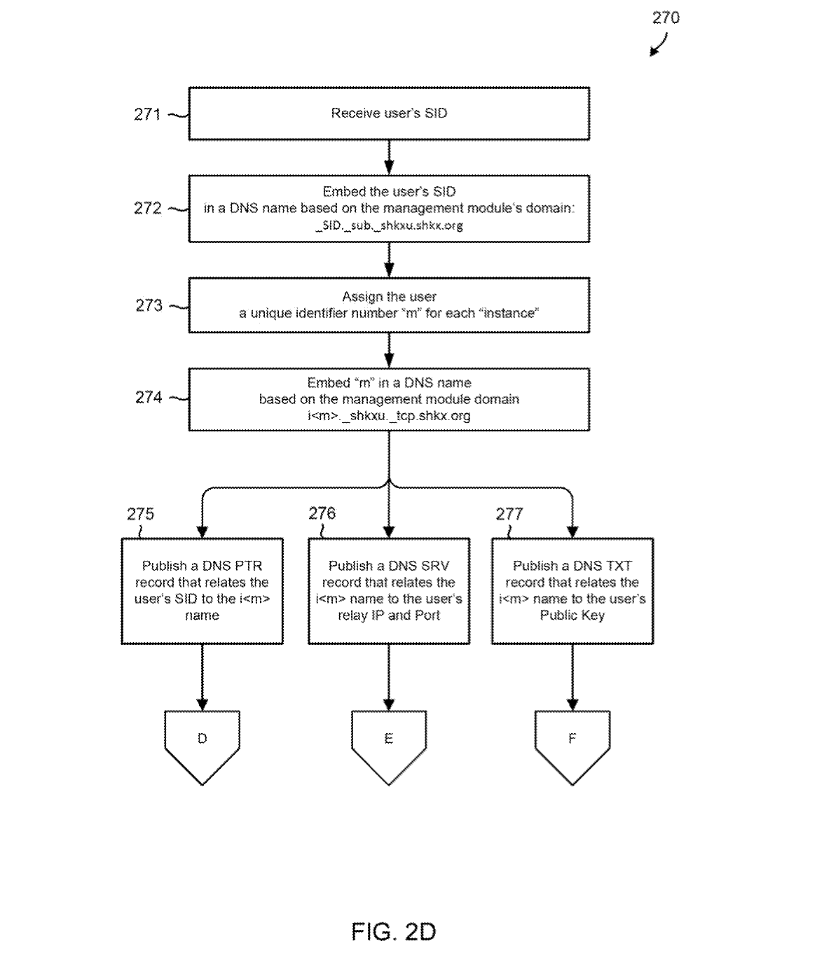

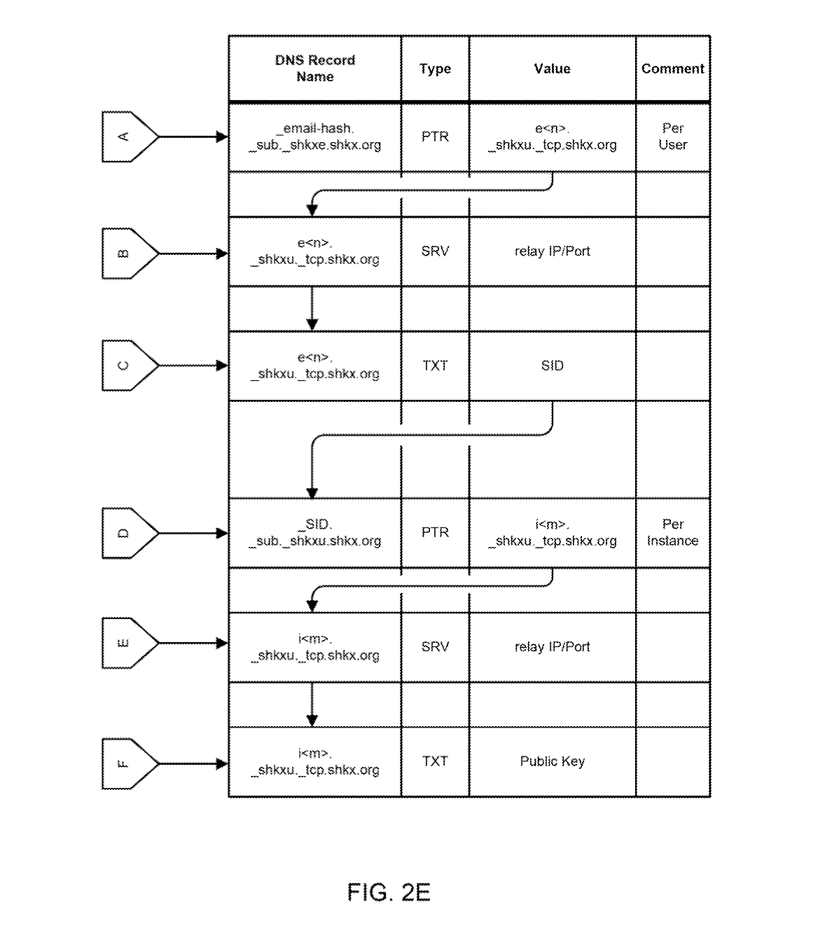

FIG. 2A illustrates various components, operations, and information flows in an example data replication system 200 that may be configured to perform a registration method 201 to register a new user in accordance with an embodiment. The operations of method 201 may be performed by one or more processing cores in one or more computing devices.

In the example illustrated in FIG. 2A, the data replication system 200 includes a user module 202, a client module 204, a management module 206, and a management domain name service (DNS) module 208. Each of these modules 202-208 may be implemented in software, hardware, or a combination of hardware and software. In an embodiment, the user module 202 may be included in the client module 204. In an embodiment, the user module 202 may be a user interface of the client module 204.

In operation 220, the user module 202 may receive or generate user input, and send the received/generated user input to the client module 204. The user input may include identification information (e.g., email address), user information, password information, nickname, and/or other similar information that is suitable for use in registering a new user to access or use the system 200. In an embodiment, the user module 202 may send the user input to the client module 204 in response to detecting the actuation of a button or key, such as a register button rendered in an electronic display of a computing device.

In operation block 222, the client module 204 may generate a key pair and system identifier (e.g., SID) for the new user based on the information received from the user module 202. In operation 224, the client module 204 may send a Nonce request message to the management module 206. In operation 226, the management module 206 may send a cryptographic Nonce object or value to the client module 204. The Nonce may be a time-sensitive and/or randomized (or pseudo-random) number or value that may be used to ensure that the communication is timely or that an old communication, such as one containing a nonce that has expired, is not reused (e.g., cannot be replayed). In operation 228, the client module 204 may generate one or more objects that include the new user's information, public key, and the Nonce. Also in operation 228, the client module 204 may sign the generated objects, and send the Nonce, the objects and the signature to the management module 206.

In operation block 230, the management module 206 may use the received Nonce, the received signature and the received public key values to validate the received objects, to validate the Nonce, and/or to validate the signature on the message. In operation block 232, the management module 206 may register the new user as pending or as a pending user if the received objects are validated, such as by adding the user/client to a database without publishing its presence. In operation 234, the management module 206 may send a user confirmation communication message to the client module 204 to notify it that a user action or confirmation has been requested and/or is required before the user's registration is changed from pending to active. In operation 236, the client module 204 may send a communication message to the user module 202 to inform it that the registration is pending confirmation.

In operation 238, the management module 206 may send a communication message to the user module 202 based on the registration information provided by the user module 202 and/or the client module 204. For example, in operation 238, the management module 206 may send a registration confirmation email communication message to an email address provided by user module 202 (e.g., in operation 220 discussed above). The email may include instructions for completing the registration process, a link to a registration server, etc.

In operation 240, the management module 206 may receive a registration confirmation communication message from the user module 202. In operation block 242, the management module 206 may change the user's registration status from “pending” to “active” or “available,” and commence operations to publish or assert the user/client's presence in the system. In operation block 244, the management module may assign a relay device to the user module 202 and/or the client module 204. In operation 246, the management module 206 may send a DNS dynamic update communication message to the management DNS module 208 to register the client and assigned relay.

FIG. 2B illustrates an embodiment registration method 250 of registering a new user to access and use the file replication system. The operations of method 250 may be performed by a processing core of a computing device, such as a computing device that includes or implements the client module 204.

In block 251, the processing core may post a registration page to a computing device's user interface so that it may be viewed by a user. In block 252, the processing core may receive registration information from the user via the user interface. In block 253, the processing core may generate an application/client identifier and public-private key pair. In block 254, the processing core may request a Nonce from a management module 206. In block 255, the processing core may receive the Nonce from the management module 206, and generate a new user message that includes the registration information and Nonce. In block 256, the processing core may encrypt and/or sign the new user message. In block 257, the processing core may send the new user message to the management module 206. In block 258, the processing core may receive a user configuration required message, which may be a communication message that indicates that a user confirmation is required. In block 259, the processing core may send a communication message to notify the user that registration is pending confirmation. In response, the user may confirm his/her registration by clicking a link in an email received from the management module 206.

FIG. 2C illustrates an embodiment method 260 of publishing information to a DNS module for a user and/or client device. The operations of method 260 may be performed by a processing core of a computing device.

In block 261, the processing core may receive a user's email address (or other identifier). In block 262, the processing core may encode a hash of the user's email address. In block 263, the processing core may embed the hashed and encoded email address in a DNS name based on the management module domain (e.g., _<hash>. _sub. _shkxe. shkx. org). In block 264, the processing core may assign the user a unique identifier number (e.g., “n”). In block 265, the processing core may compute a name by embedding the unique identifier number (e.g., “n”) in a DNS name based on the management module domain (e.g., e<n>. _shkxu. _tcp. shkx. org). In block 266, the processing core may publish a DNS a pointer record (PTR) that relates the email hash name to the computed name (e.g., e<n>). In block 267, the processing core may publish a DNS service record (SRV) that relates the computed name (e.g., e<n>) to the user's relay IP and Port. In block 268, the processing core may publish a DNS text record (TXT) that relates the computed name (e.g., e<n>) to the user's SID.

FIG. 2D illustrates another embodiment method 270 of publishing information to a DNS module for a user and/or client device. The operations of method 270 may be performed by a processing core of a computing device. In an embodiment, the operations of method 270 may be performed after the operations of method 260.

In block 271 of method 270, the processing core may receive a user's SID. In block 272, the processing core may compute an instance embed the user's SID in a DNS name based on the management module's domain (e.g., _SID._sub._shkxu.shkx.org). In block 273, the processing core may assign the user a unique identifier number (e.g., “m”) for each “instance.” That is, each user may have multiple instances of a client, and in block 273, the processing core may assign an identifier for each of these instances. In block 274, the processing core may compute a name by embedding the unique identifier number (e.g., “m”) in a DNS name based on the management module domain (e.g., i<m>._shkxu._tcp.shkx.org). In block 275, the processing core may publish a DNS a pointer record (PTR) that relates the user's SID to the computed name (e.g., i<m>). In block 276, the processing core may publish a DNS service record (SRV) that relates the computed name (e.g., i<m>) to the user's relay IP and Port. In block 277, the processing core may publish a DNS text record (TXT) that relates the computed name (e.g., i<m>) to the user's Public Key.

FIG. 2E illustrates example information published to the DNS for the user and/or client device after the performance of methods 260 and 270. FIG. 2E also illustrates that a processing core may use the DNS pointer record (PTR) that relates the email hash name (_email-hash._sub._shkxe.shkx.org) to the computed name (e<n>._shkxu._tcp.shkx.org) to identify and retrieve DNS records that identify the relay IP, port, and SID values for the user. The processing core may then use the user's SID value to identify a DNS pointer record (PTR) that includes an instance name (i<m>._shkxu._tcp.shkx.org), which the processing core may use to identify and retrieve DNS records that identify the relay IP, port, and public key values for each instance.

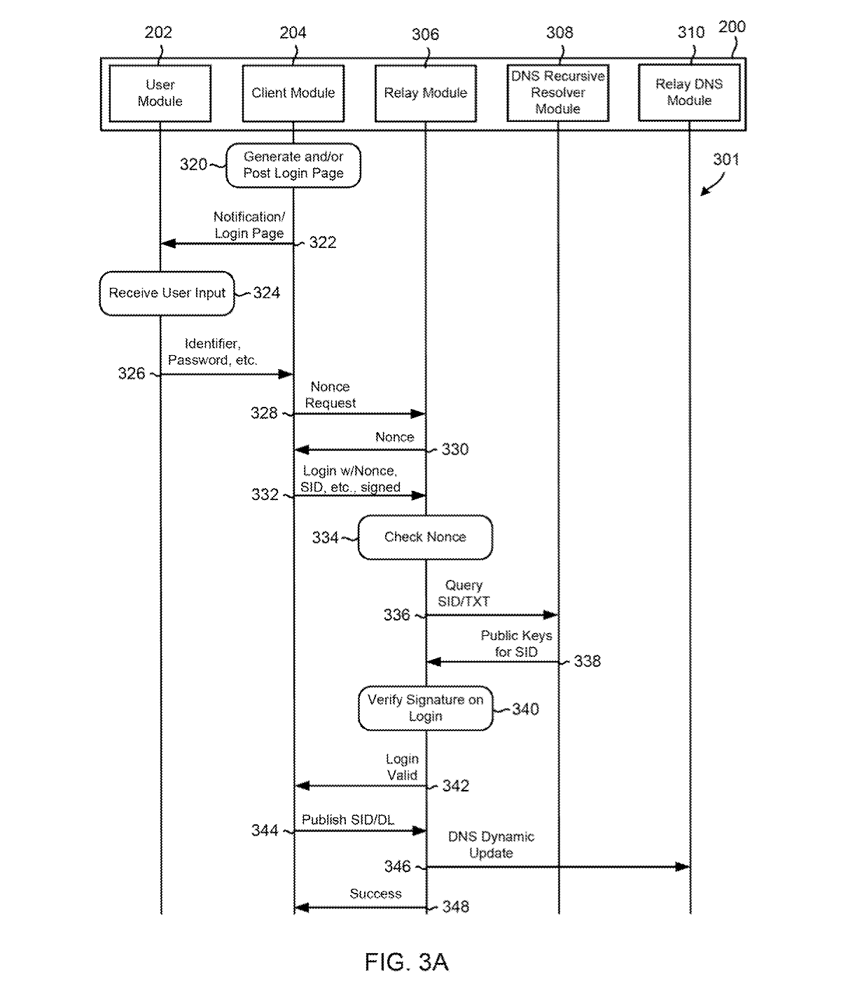

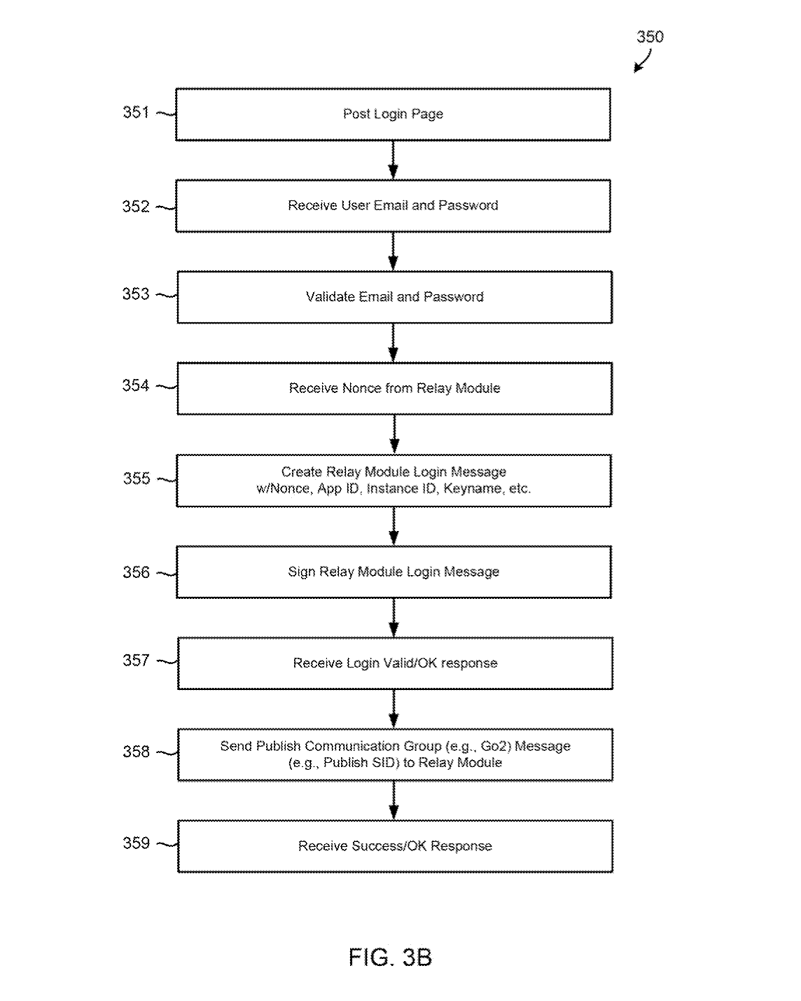

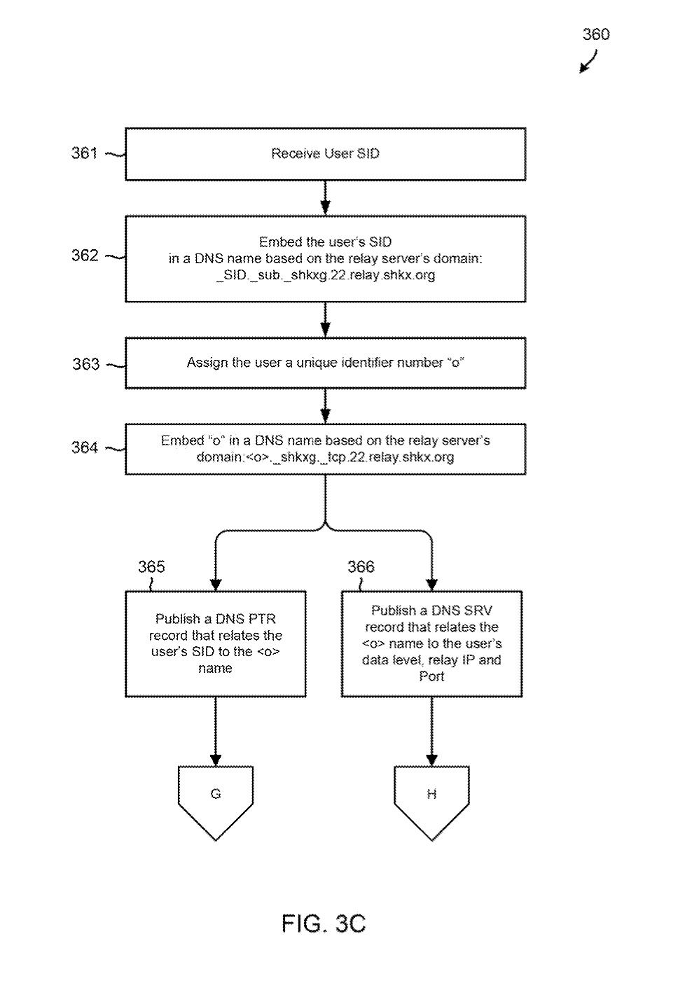

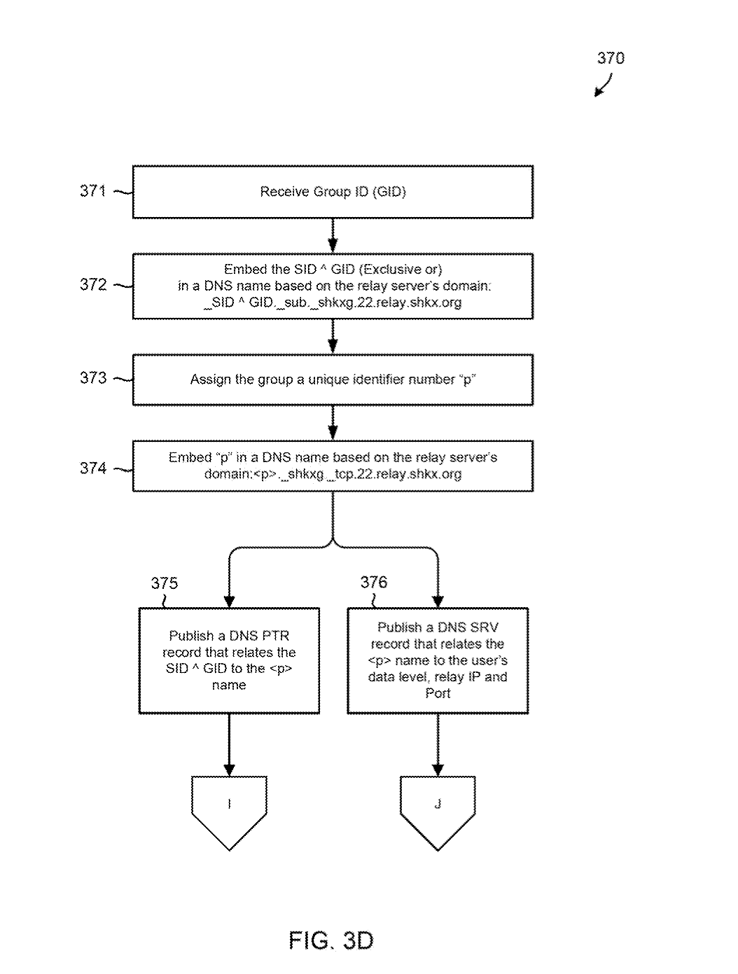

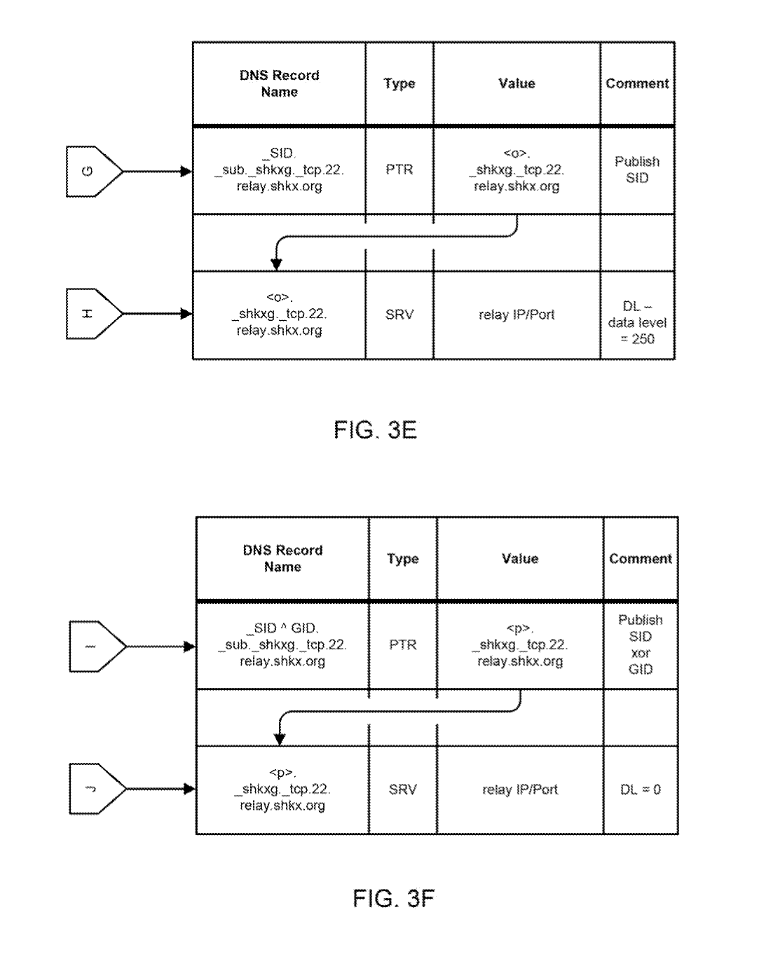

FIG. 3A illustrates various components, operations, and information flows in a data replication system 200 configured to perform an embodiment login method 301 of providing one or more users access to use the system 200. In the example illustrated in FIG. 3A, the data replication system 200 includes a user module 202, a client module 204, a relay module 306, a DNS recursive resolver module 308 and a relay DNS module 310. The operations of method 301 may be performed by one or more processing cores in one or more computing devices. Each of the modules 202, 204, 306-310 may be implemented in software, hardware, or a combination thereof.

In operation block 320, the client module 204 may commence operations by generating, posting, and/or publishing a login page or information structure that may be used to store and/or receive login information from the user module 202. For example, in operation block 320, the client module 204 may generate HTML, JavaScript, and cascading style sheets (CSS) that are suitable for requesting and receiving login information from the user module 202. In operation 322, the client module 204 may notify the user module 202 that the login page has been published, or send the client module 204 the generated login page or information structure. In operation block 324, the client module 204 may request, receive, and/or generate user input in response to receiving the login page or information structure. This user input may include a user identifier, a password, and/or other similar information that is suitable for use in verifying that the user has permission to access or use the system 300.

In operation 326, the user module 202 may send the user input to the client module 204. In an embodiment, the user module 202 may be configured to send the user input to the client module 204 in response to detecting the actuation of a login button or key. In operation 328, the client module 204 may send a Nonce request message to the relay module 306. In operation 330, the relay module 306 may send a cryptographic Nonce object or value to the client module 204.

In operation 332, the client module 204 may perform various authentication operations, generate one or more objects based on these operations and information received from the user module 202 and/or relay module 306, and send the generated object to the relay module 306. For example, the client module 204 may retrieve or generate login information, SIDs, IIDs, signatures, keynames, and validation/verification information, generate objects and/or communication messages that include the received Nonce and generated information, sign the messages with the user's private key and send the objects/messages to the relay module 306.

In operation block 334, the relay module 306 may receive the objects/messages from the client module 204, and check, validate, or verify the Nonce to ensure that the information or communication is valid or from a valid source. In operation 336, the relay module 306 may send a communication message that includes the received SID to query to the DNS recursive resolver module 308 for public keys. In operation 338, the DNS recursive resolver module 308 may query a database, and/or DNS authorities to retrieve the public keys based on the received SID, and send a DNS response message that includes the public keys to the relay module 306.

As a more detailed example, the DNS recursive resolver may look up the answer to the query in its cache (which may be a database) or query the DNS authorities (e.g., the nameservers in the DNS name hierarchy) or an upstream DNS resolver to answer the query. Further, the client module may generate a key pair (public/private key) and publish the public key using the management server/module and DNS. To use DNS, the management server/module may update a DNS zone by publishing a DNS dynamic update with the keying information to the zone's nameserver. That action may publish the key to DNS. To consume a key, a relay module may query a DNS recursive resolver for the key of a given SID. The DNS recursive resolver may then perform various DNS operations to answer the query and return the information that is requested (e.g., a public key).

Returning to FIG. 3, in operation block 340, the relay module 306 may use the public keys to validate or verify that the signature on the login information is correct and/or has not been altered or modified. In operation 342, the relay module 306 may send a notification message to the client module 204 to inform it that the login information is correct and/or has not been altered or modified. In operation 344, the client module 204 may publish the SID and/or data level (DL) by sending them to the relay module 306. In operation 346, the relay module 306 may send a DNS dynamic update communication message to the relay DNS module 310 to register the client and/or assigned relay. In operation 348, the relay module 306 may send a notification message to the client module 204 to inform it that the login operations were successful.

FIG. 3B illustrates an embodiment login method 350 of providing a user access to use the file replication system. The operations of method 350 may be performed by a processing core of a computing device.

In block 351, the processing core may post a login page so that it may be viewed by a user. In block 352, the processing core may receive user email and password information. In block 353, the processing core may validate the user's email and password information. In block 354, the processing core may receive a Nonce from relay module 306. In block 355, the processing core may create a relay module login communication message that includes the Nonce, an application/client ID, an instance identifier, keyname, etc. In block 356, the processing core may encrypt and/or sign relay module login communication message. In block 357, the processing core may receive login valid/ok response. In block 358, the processing core may send a publish communication group (e.g., go2) communication message (e.g., publish SID) to relay module 306. In block 359, the processing core may receive success/OK response message.

FIG. 3C illustrates an embodiment method 360 of publishing static information on DNS for a user and/or client device. The operations of method 360 may be performed by a processing core of a computing device.

In block 361, the processing core may receive a user SID value. In block 362, the processing core may embed the user's SID in a DNS name based on the relay module domain (e.g., _SID. _sub. _shkxg. 22. relay. shkx. org). In block 363, the processing core may assign the user a unique identifier number (e.g., “o”). In block 364, the processing core may compute a name by embedding the unique identifier number (e.g., “o”) in a DNS name based on the relay module's domain (e.g., <o>. _shkxg. _tcp. 22. relay. shkx. org). In block 365, the processing core may publish a DNS pointer record (PTR) that relates the user's SID to the computed name (e.g., <o>). In block 366, the processing core may publish a DNS service record (SRV) that relates the computed name (e.g., <o>) to the user's data level, relay IP, and port.

FIG. 3D illustrates another embodiment method 370 of publishing static information on DNS for a user and/or client device. The operations of method 370 may be performed by a processing core of a computing device. In embodiment, the operations of method 370 may be performed after the operations of method 360.

In block 371 of method 370, the processing core may receive a group ID (GID) value. In block 372, the processing core may computed the exclusive OR of the SID and GID values, and embed the result in a DNS name based on the relay module domain (e.g., _SID ̂ GID. _sub. _shkxg. 22. relay. shkx. org). In block 373, the processing core may assign the group a unique identifier number (e.g., “p”). In block 374, the processing core may embed the unique identifier number (e.g., “p”) in a DNS name based on the relay module domain (e.g., <p>. _shkxg. _tcp. 22. relay. shkx. org). In block 375, the processing core may publish a DNS pointer record (PTR) that relates the SID ̂ GID to the computed name (e.g., <p>). In block 376, the processing core may publish a DNS service record (SRV) that relates the computed name (e.g., <p>) to the user's data level, relay IP and port.

FIGS. 3E and 3F illustrate example information that may be published to the DNS (e.g., relay DNS module 310 illustrated in FIG. 3A) for the user and/or client device after the performance of methods 360 and 370.

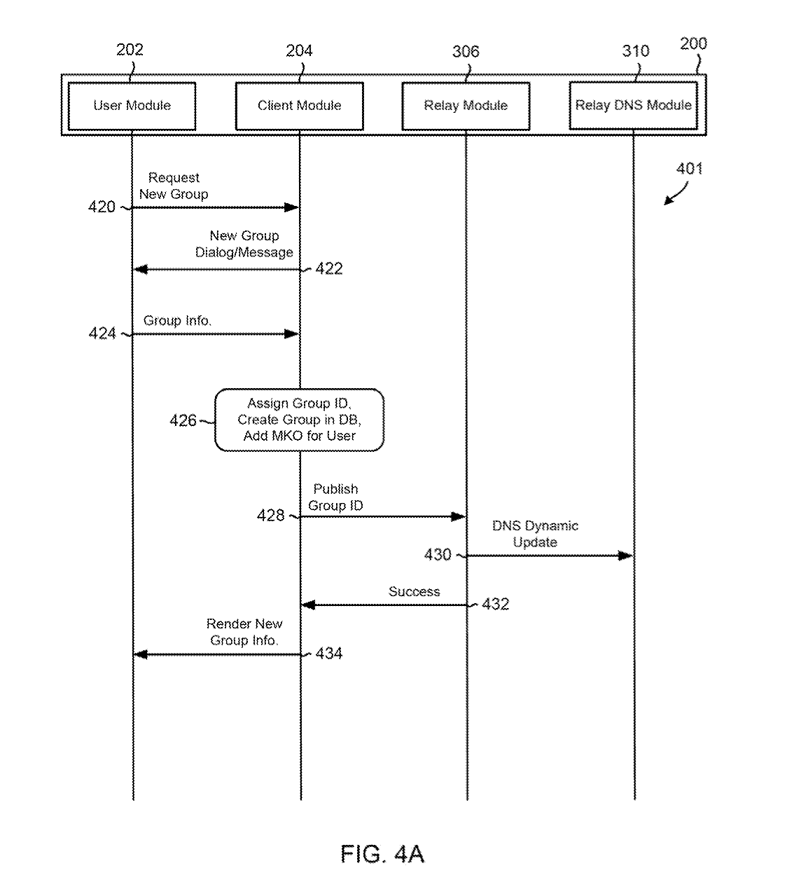

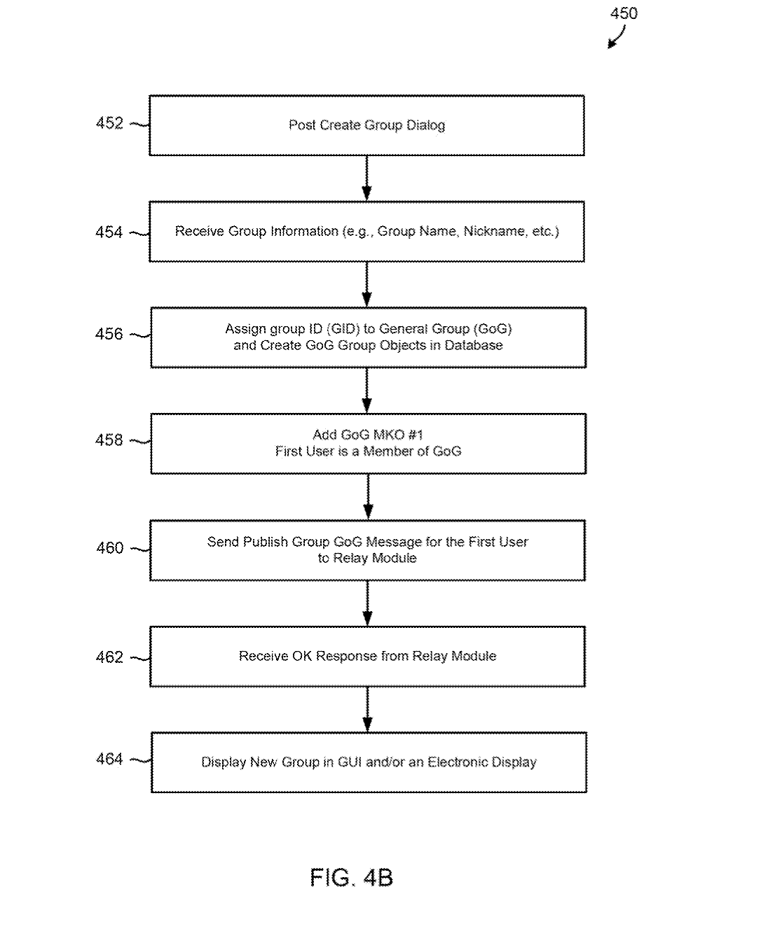

FIG. 4A illustrates various components, operations, and information flows in a data replication system 200 configured to perform an embodiment method 401 of creating collaboration groups, which may be used to when establishing P2P-based communication networks and replicating documents. In the example illustrated in FIG. 4A, the data replication system 400 includes a user module 202, a client module 204, a relay module 306, and a relay DNS module 310. The operations of method 401 may be performed by one or more processing cores in one or more computing devices.

In operation 420, the user module 202 may request the creation/formation of a new group by sending a group formation request message to the client module 204. In an embodiment, the user module 202 may send the group formation request message to the client module 204 in response to detecting the actuation of a button or key, such as a group button that is rendered in an electronic display of a computing device. In operation 422, the client module 204 may generate and send a new group formation dialog, message, page, or information structure to the user module 202. In operation 424, the user module 202 may render the information received from the client module 204, receive group information (e.g., group name, etc.) as user input, and send the receive group information to the client module 204.

In operation block 426, the client module 204 may create a group (e.g., a group information structure), assign a group identifier to the group, add the user and user information to the group, insert the group in a database, and perform various other similar group formation operations. In operation 428, the client module 204 may send the assigned group identifier to the relay module 306 and request that the relay module 306 publish the new group as being available in the client module 204.

In operation 430, the relay module 306 may send a DNS dynamic update communication message to the relay DNS module 310 to register the group, client, and/or assigned relay to publish this information (i.e., make the information available via DNS). In operation 432, the relay module 306 may send a notification message to the client module 204 to inform it that the group formation and group registration operations were successful. In operation 434, the client module 204 may send the group information (e.g., group identifier, group members, etc.) to the user module 202, which may receive and render the group information on an electronic display of a computing device.

FIG. 4B illustrates an embodiment method 450 of creating and adding a user to a communication or collaboration group. The operations of method 450 may be performed by a processing core of a computing device.

In block 452, the processing core may post a “create group” dialog so that it may be viewed by a user, such as by displaying the dialog in an electronic display of the computing device. In block 454, the processing core may receive group information (e.g., group name, nickname, etc.). In block 456, the processing core may create a general group (GoG), assign a group ID (GID) to the general group (GoG), and add the general group (GoG) objects to a database. In block 458, the processing core may add a GOG Membership Keying Object (MKO) denoted MKO 1 to the database, so that the first user is a member of the general group (GoG). In block 460, the processing core may send publish a group GoG message for the first user to relay module 306. In block 462, the processing core may receive an OK response from relay module 306. In block 464, the processing core may display new group in GUI and/or the electronic display of the computing device.

Generally, group membership may allow a group member to add another user to a group, remove another user (including itself) from a group, add another instance (of itself—e.g., another device) to a group, remove one of their instances from a group.

When communications are accomplished via peer-to-peer communications, there is no central authority that determines group membership. As such, in the various embodiments, group membership may be managed and controlled by each client device processing the group's Membership Keying Objects (MKOs) that, in total, identify the current and past members of the group.

Various embodiments may use an invitation object, RSVP object and MKO to generate, manage and/or control a group. The invitation object may include an Object ID value, Group ID value, Object Type value, Object Version value, Timestamp value, Inviter SID value, Invitee SID value, Group Name value, Invitee IID[i] value, Inviter IID value, and a Signature value. The Object ID value may be a unique identifier of the invitation object. The Group ID value may be a unique identifier for the group. The Object Type value may identify the object as being an “Invitation” object. The Object Version value may be number suitable for identifying the version of the object. The Timestamp value may be a date and time of the invitation. The Inviter SID value may be unique identifier of an inviter user. The Invitee SID value may be unique identifier of the invitee user. The Group Name value may be a text or human readable name of the group. The Invitee IID[i] value(s) may be a unique identifier(s) of the invitee's instances that are known to the inviter. Inviter IID value may be a unique identifier of the author's (the inviter's) signing instance and/or an identifier of a public key that matches the private key that signed the object. The Signature value may be a cryptographic signature of the author (the inviter) over the object.

The RSVP object may include an Object ID value, Group ID value, Object Type value, Object Version value, Timestamp value, an Invitation, Response value, X.509 Cert, and a Signature value. The Object ID value may be a unique identifier of the RSVP object. The Group ID value may be a unique identifier for the group. The Object Type value may identify the object as being an “RSVP” object. The Object Version value may be number suitable for identifying the version of the object. The Timestamp value may be a date and time of the response. The Invitation may be a complete invitation object to which this is a reply. The Response value may include information identifying acceptance or rejection of the invitation. The X.509 Cert may be a certificate that includes the public key of the instance of the responding user (the sha256 hash of this public key may also be the instance ID of the responding user's instance). The Signature value may be a cryptographic signature of the author (the responder) over the object.

The Membership Keying Object (MKO) may include an Object ID value, Group ID value, Object Type value, Object Version value, Timestamp value, Inviter SID value, Previous MKO value, ExSID[i] value(s), ExIID[i] value(s), NewRSVP[i], EncryptedKey[i], OldMkoId[i] value(s), WrappedKey[i] value(s), Inviter IID value, and Signature. The Object ID value may be a unique identifier of the MKO. The Group ID value may be a unique identifier for the group. The Object Type value may identify the object as being a “MKO” object. The Object Version value may be number suitable for identifying the version of the object. The Timestamp value may be a date and time of the response. The Inviter SID value may be a unique identifier of the inviter user. The Previous MKO value may include an Object ID of the most recent previous MKO for the group. The ExSID[i] value(s) may be unique identifiers of all users being removed from the group. The ExIID[i] value(s) may be unique identifiers of all instances being removed from the group (e.g., for a user that wishes to remove some, but not all, of their instances from a group). The NewRSVP[i] may include a complete RSVP object for all users being added to the group. The EncryptedKey[i] may include current group encryption key, wrapped by the public key of every instance of every user now in the group. The OldMkoId[i] value(s) may include the object ID of every MKO this MKO directly replaces. For each of the last n group keys K, the WrappedKey[i] may include the Object ID of K and the value of K wrapped by the current Group Key, denoted as [Id(k[i]), W(k[i],CGK)]. The Inviter IID may be a unique identifier of author's (the inviter's) signing instance and/or an identifier of a public key that matches the private key that signed the object. The Signature value may be a cryptographic signature of the author (the inviter) over the object.

In an embodiment, the system may be configured so that, when a group is first created, a group key is created along with the group. The group key may be a symmetric cryptographic key that is used by the computing devices to encrypt and decrypt the object keys that are used to encrypt and decrypt other objects of the group. The group key may be a secret that may be known only to members of the group, strictly delineated by their terms of membership. In other words, a user that was previously a member of a group but is no longer a member of a group would be able to decrypt data that was in the group prior to and during their term of membership, but not data that was added to the group after the completion of their membership term.

The Membership Keying Object may be a data structure that may be used by the computing devices to mediate the features of group membership. In the normal course of events, an inviter user device/instance adds an invitee user device/instance to a group by sending the invitee an invitation object. The invitee responds with an RSVP object that accepts or rejects the invitation. If the invitee accepts the invitation, the inviter performs a check before proceeding. For example, the inviter may determine whether the key the invitee used to sign the RSVP matches one of the Invitee IIDs listed in the invitation. If this check passes, the inviter may create an MKO that adds the new member to the group, add this MKO to the group (making it available for synchronization to other members of the group), and send the invitee the Membership Keying Object (since the invitee is not yet in the group, they may be required receive the MKO that put them into the group “out of band”). In an embodiment, the system may be configured so that all group members must perform the check on the RSVP's Signature before accepting an MKO that adds members or instances to a group.

In the various embodiments, the Membership Keying Object may include a group key that is wrapped (encrypted) by the public key of every user instance in the group, including the new user. This allows the system to operate such that any one of these users can unwrap (decrypt) the group key using their private key, and use the decrypted group key to encrypt data to put in the group or decrypt data to read from the group. Similar to the check performed on the RSVP object, the recipient of an MKO may check the signature on the MKO, as well as the signature on any nested invitations and their RSVPs.

Various embodiments may be configured to change the group key under various circumstances. For example, if there are multiple active group keys (resulting from distributed/disconnected actions as will be explained later) a new key may be created by an instance that is about to create an object for the group. An MKO suitable for changing the group key may be created immediately prior to creating the other new object. The group key may also change when a user (or instance) leaves a group, and may be determined by organizational cryptographic policy that specifies for how long and on how much data a symmetric key may be used. In an embodiment, the computing devices may use a 256-bit AES for the symmetric keys.

When a user leaves a group, the group key may be changed so that the user would not still be able to decrypt data from the group. How the group key is changed depends on how the user left. If a user is evicted from the group by another member, then the group member that evicts the user creates a new group key and issues a new Membership Keying Object for the group. That Membership Keying Object indicates the SID of the evicted user in the ExSID list. The new MKO may be synchronized to all the now current group members and they use it to determine the new membership of the group (recognizing the eviction of a user by that user's SID in the exSID list). They may also use the new group key for future encryption and decryption of data for the group.

If a user elects to leave the group by themselves, then the leaving user uses the same mechanism and issues a new MKO, specifying itself in the ExSID list. The only difference is that the next time a user creates an object in the group, they will recognize the self-eviction of a user and create a new group key and publish that in another new MKO. (This is so that the self-evicted member of the group will not be able to decrypt new data added to the group.) If this happens simultaneously with two users, then the next user that creates a new object and sees that there are multiple group keys creates a new group key and issues a new MKO that consolidates the multiple group keys. This process may continue until the group “converges” with only one group key surviving. It should be noted that full convergence may not occur and is not required. In an often disconnected group with membership churn there may be multiple active group keys at any time. This situation may hold until the next time that the group key changes. A user that elects to remove one of their instances may do so in a similar fashion, but by using the ExIID list.

A new MKO may be issued whenever a new member joins a group. Yet, the group key need not change. To add a new user to the group, the current group key may be wrapped for the new user (the key is wrapped with the new member's public key) and the new wrapped key and its ID may be added to the MKO in the WrappedKey field. A new MKO is added to the group, but this new MKO uses the existing group key.

As was mentioned above, various embodiments may use symmetric keys (AES-256) for group keys (any block cipher with standard modes of operation such as AES-128, Triple-DES would do). Group keys may be created anew from random bits when the group is first created, when a user (or a user's instance) leaves a group, when there is more than one active key in the group as can arise when a user leaves a group voluntarily, and by a key lifetime policy. Group keys may be wrapped by asymmetric keys.

Various embodiments may also use symmetric keys (again, AES-256) for object keys to encrypt every object. Object keys may be wrapped (encrypted) with the group key, such as to limit the exposure of the user's public/private key pair, to limit the exposure of the group key, and/or for performance reasons (i.e., symmetric keying may be much more efficient than asymmetric keying, in the sense that symmetric keying consumes much less compute resource than asymmetric keying).

Various embodiments may use ECC-256 (NID_secp256k1) for asymmetric keys (e.g., public/private key pairs). Other embodiments may use any of variety of public key algorithms, with signature and key wrapping/agreement modes, such as RSA or DSA and DH. A symmetric key agreement key may be generated for each pairing of the creating instance of the MKO each other key for instances in the group. This may be accomplished using Elliptic Curve Diffie-Hellman. These key agreement keys may be used to encrypt (wrap) the new group key. In the case of the pairing of the creating instance and itself, an ephemeral key may be used.

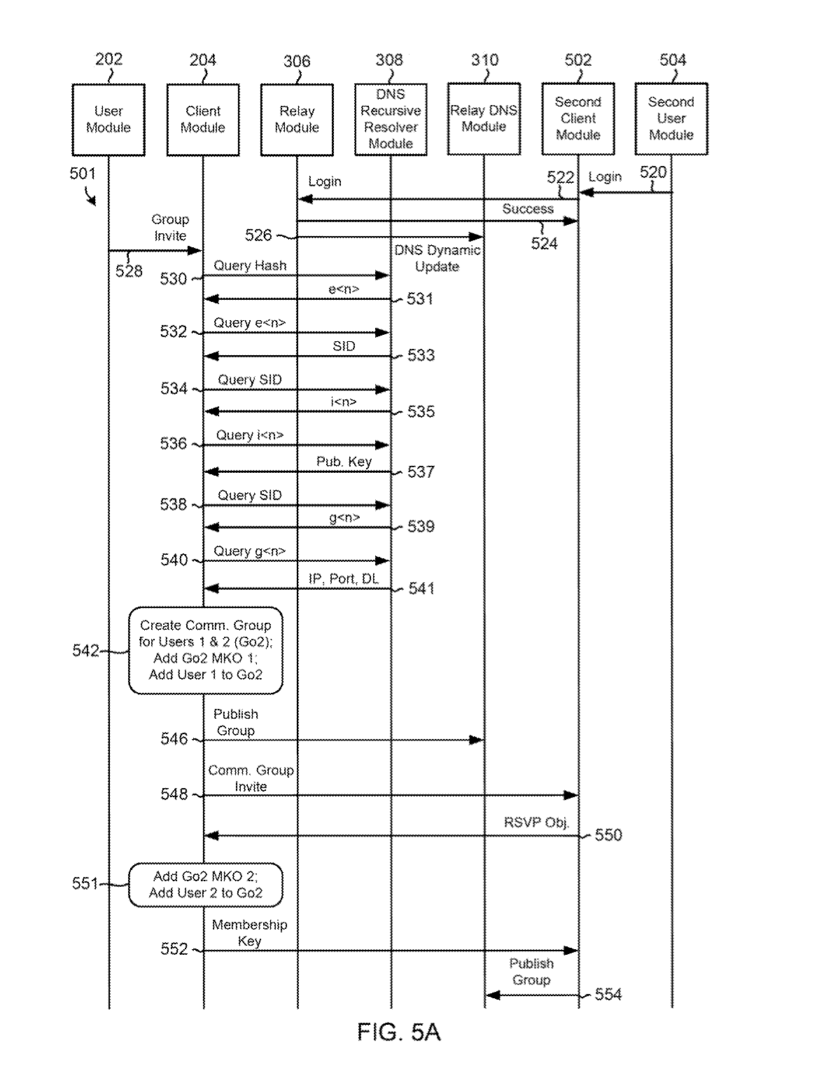

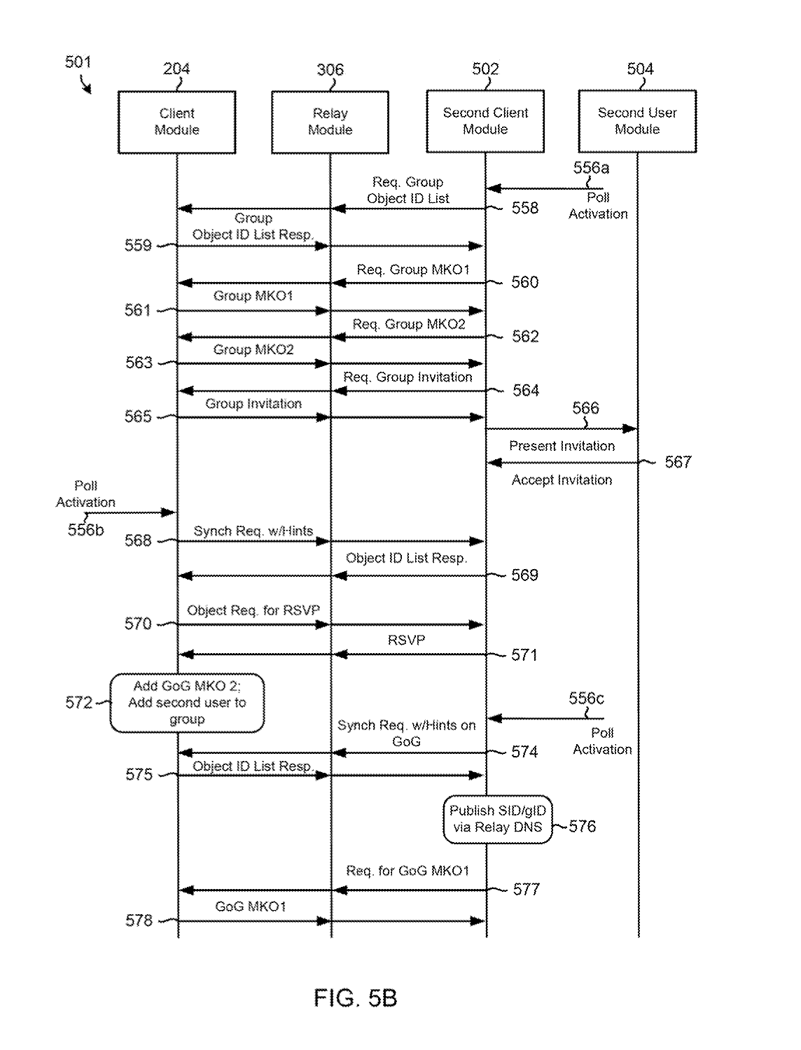

FIGS. 5A-B illustrate various components, operations, and information flows in a data replication system configured to perform an embodiment method 501 of adding a user/device to a collaboration group. The operations of method 501 may be performed by one or more processing cores in one or more computing devices.

In the example illustrated in FIGS. 5A and 5B, the data replication system includes a user module 202, a client module 204, a relay module 306, a DNS recursive resolver module 308, a relay DNS module 310, a second client module 502, and a second user module 504. Each of these modules may be implemented in software, hardware, or a combination thereof. The second user module 504 may be included in, or may be a user interface of, the second client module 502.

In operations 520-526 of FIG. 5A, the second user module 504, second client module 502, the relay module 306, and relay DNS module 310 may perform a logon method (e.g., method 301 discussed above) to provide a second user with access to the data replication system. For example, in operation 520, the second user module 504 may receive login information as user input (e.g., identifier, password, etc.), and send the user input to the second client module 502. In operation 522, the second client module 502 may retrieve and send login information, SIDs, IIDs, signatures, keynames, a Nonce, and other validation/verification information to the relay module 306. In operation 524, the relay module 306 may check the Nonce, use the SID to request and receive public keys, use the public keys and/or keynames to validate signatures, and send a notification message to the client module 204 to inform it that the login information is correct and/or that the login operations were successful. In operation 526, the relay module 306 may send a DNS dynamic update communication message to the relay DNS module 310 to register the client and/or assigned relay.

In operation 528, the user module 202 may receive user input in the form of a request to add a second user to the communication group, and send a group invite message to the client module 204.

In operations 530-541, the client module 204 may communicate with the DNS recursive resolver module 308 to determine the protocol, port, and data level values that may be used to identify and communicate with the relay module 306 that is assigned to the user/client.

More specifically, in operation 530, the client module 204 may query the DNS recursive resolver module 308 with a hash of the user's email address. That is, in operation 530, the client module 204 may communicate the hash of the user's email address to the DNS recursive resolver module 308. The DNS recursive resolver module 308 may receive and use the hash to retrieve a pointer record (PTR) that may be used to determine an eN value that identifies the user, and send the retrieved pointer record to the client module 204 in operation 531. The pointer record (PTR) may be a database record, a DNS record, resource record, etc. The pointer record (PTR) may include a pointer to a canonical name.

In operation 532, the client module 204 may query the DNS recursive resolver module 308 with the eN value to identify a SID. The DNS recursive resolver module 308 may receive and use the eN value to retrieve a text record (TXT) that identifies a SID, and send the SID to the client module 204 in operation 533.

In operation 534, the client module 204 may query the DNS recursive resolver module 308 with the SID to identify an instance for the identified user. The DNS recursive resolver module 308 may receive and use the received SID to retrieve a pointer record (PTR) that may be used to determine an iN value that identities an instance for the identified user, and send the iN value to the client module 204 in operation 535.

In operation 536, the client module 204 may query the DNS recursive resolver module 308 with the iN value to identify the public key of the instance. In operation 537, the DNS recursive resolver module 308 may use the received iN value to retrieve the user's public key, and send the public key to the client module 204.

In operation block 542, the client module 204 may use the received information to generate a communication group (Go2) for the client modules 204, 502, add a communication group (Go2) MKO for the first user (modules 202, 204) to the communication group, and add the first user to the communication group (Go2). This communication group (Go2) may be used to communicate information for establishing and joining a collaboration group. In an embodiment, the client module 204 may also select a relay IP, port, and data level for the relay module 306 in operation block 542. That is, the second user/client may be associated with more than one relay device, and thus in operation block 542, the client module 204 may select the relay module 306 as the relay device that will be used to communicate information between the client modules 204, 502.

In operation 538, the client module 204 may query the DNS recursive resolver module 308 with the SID to identify a group for the identified instance and/or user. In operation 539, the DNS recursive resolver module 308 may use the received SID to retrieve a pointer record (PTR) that may be used to determine an gN value that identities a group for the identified instance and/or user.

In operation 540, the client module 204 may query the DNS recursive resolver module 308 with the gN value to identify a relay IP, relay port, and data level. In operation 541, the DNS recursive resolver module 308 may use the received gN value to identify one or more relays (e.g., via relay IPs, relay ports, and data levels), and send this information to the client module 204. That is, the second client module 502 and second user module 504 (and thus the second user) may be associated with more than one relay, and the DNS recursive resolver module 308 may identify more than one relay that is associated with the second user.

In operation 546, the client module 204 may send communication group (Go2) information to the relay DNS module 310 for storage and publication. In operation 548, client module 204 may create or generate a communication group (Go2) invitation object, add the invitation object to the group (e.g., by storing it in a local collaborative memory), and send the invitation object to the second client module 502 (e.g., by synchronizing the memories, sending a notification message, etc.). In operation 550, the second client module 502 may accept the invitation to join the communication group (Go2) by generating and sending an RSVP object to the client module 204.

In operation block 551, the client module 204 may add a communication group (Go2) MKO for the second user (modules 504, 502) to the communication group, and add the second user to the communication group (Go2). In operation 552, the client module 204 may send a membership key to the second client module 502. In operation 554, the second client module 502 may send its send communication group (Go2) information to the relay DNS module 310 for storage and publication.

With reference to FIG. 5B, in operation 556a of method 501, the second client module 502 may receive a poll activation message from the second user module 504 or another component in the system. For example, the system may be configured to generate and communicate such poll activation messages (e.g., via operations 556a-c) periodically, continuously, near-continuously, repeatedly, in response to an event, and/or until every computing device in the group stores the same documents (or references/links to the documents) as every other computing device in that group. In embodiments where the poll-activation messages are performed periodically, a timer may be associated with the poll activation command such that a polling operation occurs periodically at timed intervals. In other embodiments, the poll activation may occur when another user computing device updates its respective collaboration memory store and sends a message indicating the update. In some embodiments, the receipt of an update message may short circuit the timer activation in the other member's client modules and may initiate an immediate synchronization cycle so that the documents may be synchronized without further delay due to a poll not happening for an average of ½ the polling period. This essentially approximates a push of the document to the other online members.

In operations 558 to 565, the client module 204 and second client module 502 may communicate various objects and information, either directly or via the relay module 306, to exchange information to invite the second user join to a collaboration group. The client modules 204, 502 may communicate this information via the communication group (Go2) discussed above with reference to FIG. 5A. That is, the communication group (Go2) may be used to extend an invitation to join a collaboration group, which may then be used to synchronize content and documents between computing devices.

In operation 558, the second client module 502 may send a group object ID list request message to the client module 204. In operation 559, the client module 204 may send a group Object ID list response message to the second client module 502.

In operation 560, the second client module 502 may send a first group MKO request message to the client module 204. In operation 561, the client module 204 may send a first group MKO response message (e.g., MKO of the first user) the second client module 502.

In operation 562, the second client module 502 may send a second group MKO request message to the client module 204. In operation 563, the client module 204 may send a second group MKO response message (e.g., MKO of the second user) the second client module 502.

In operation 564, the second client module 502 may send a collaboration group invitation request message to the client module 204. In operation 565, the client module 204 may a collaboration group invitation request message the second client module 502.

In operation 566 the second client module 502 may communicate the invitation to the second user module 504 to present the invitation to the user. In operation 567 the second user module 504 may receive user input accepting the invitation, and communicate the acceptance of the group invitation to second client module 502.

In operation 556b, the client module 204 may receive a poll activation message. For example, the system may be configured to generate and communicate such poll activation messages (e.g., via operations 556a-c) periodically, continuously, near-continuously, repeatedly, in response to an event, and/or until every computing device in the group stores the same documents (or references/links to the documents) as every other computing device in that group. In embodiments where the poll-activation messages are performed periodically, a timer may be associated with the poll activation command such that a polling operation occurs periodically at timed intervals.

In response, the client module 204 may communicate a synchronization request message that includes a hints list to the second client module 502 via the communication group (Go2) in operation 568. The hints list may include hash values for object IDs of objects of documents that are stored in a collaboration memory of the client module 204 but not in the collaboration memory of the second client module 502. In operation 569, the second client module 502 may send an object ID list response message to the client module 204. In operation 570, the client module 204 may send an object request message to the second client module 502. In operation 571, the second client module 502 may send an RSVP object to the client module 204 to accept the invitation to the collaboration group. In operation block 572, the client module 204 may add a GoG MKO2 and add the second user to the group.

It should be noted that every object that is conveyed to a client by the synchronization mechanism, e.g., in the case of a document, the Handle, Naming, File and 1 or more Atom Objects, may be acknowledged by the recipient by the generation of a signed AcknowledgeObject that contains a unique ID and the unique ID of the object that is being acknowledged. These AcknowledgeObjects may then also be synchronized (ack objects are not themselves acknowledged). This allows all members of a group to know what objects members of the group have. As an example, if there exists a document in the group consisting of Handle object H1, Naming Object N1, File Object F1 and Atom Object A1, and there are acknowledge objects Ai(H1), Ai(N1), Ai(F1) and Ai(A1) where Ai(X) is an acknowledge object signed by “i” for object X, then, as the acknowledge objects are synchronized around the group, the group members know that member “i” possess that document. A count of the number of group members that have not (fully) acknowledged the objects of a document, along with their names may be displayed on each respective user interface.

In operation 556c, the second client module 502 may receive a poll activation message. In operation 574, the second client module 502 may communicate a synchronization request message that includes a hints list to the client module 204 via the communication group (Go2). In operation 575, the client module 204 may send an object ID list response message to the second client module 502. In operation block 576, the second client module 502 may publish a SID and/or group identifier (gID) for the collaboration group to the relay DNS module 310.

In operation 577, the second client module 502 may send an object request message for the GoG MKO1 to the client module 204. In operation 578, the client module 204 may send the GoG MKO1 for the group to the second client module 502.

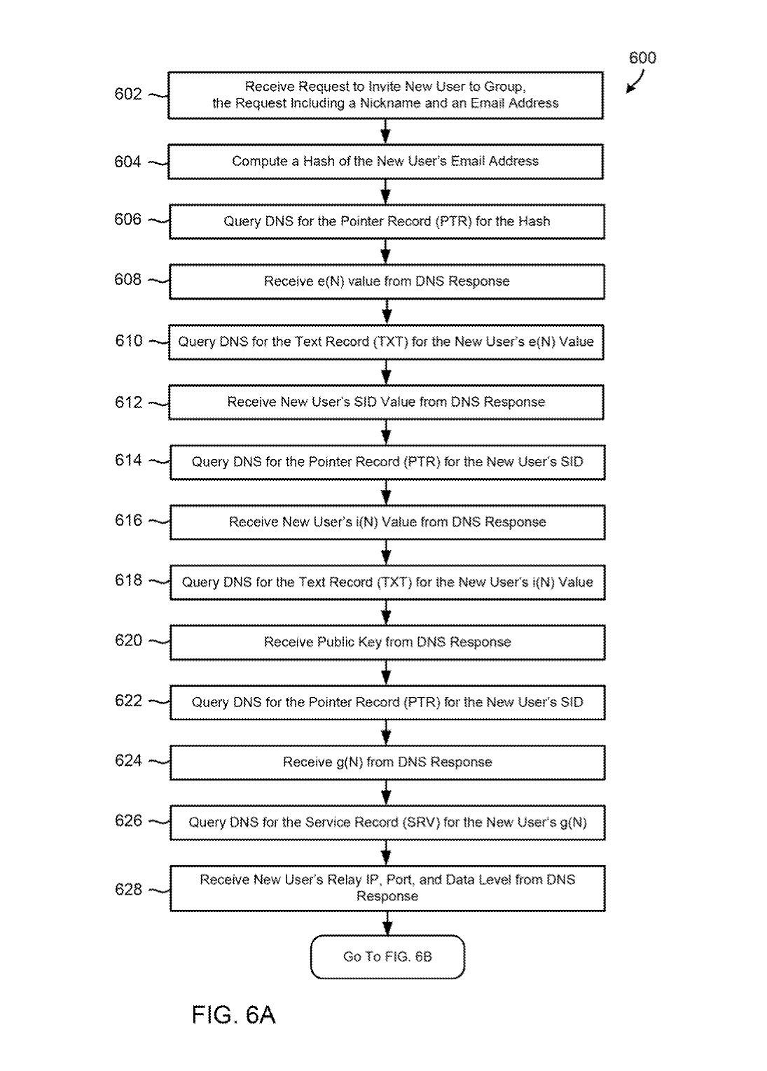

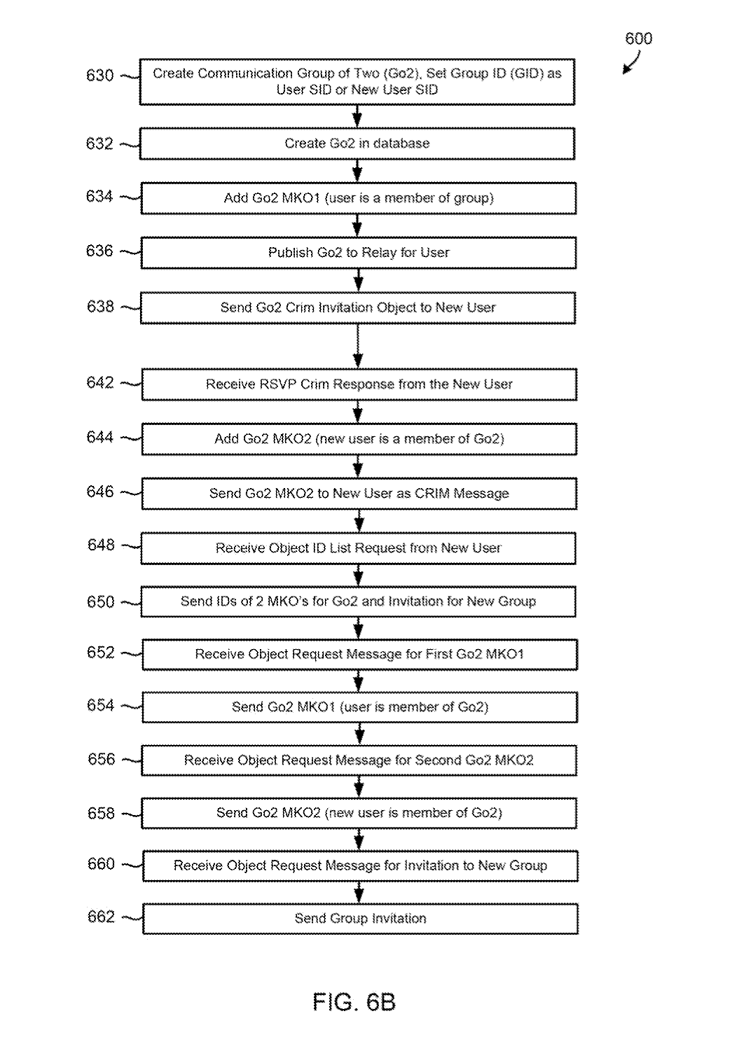

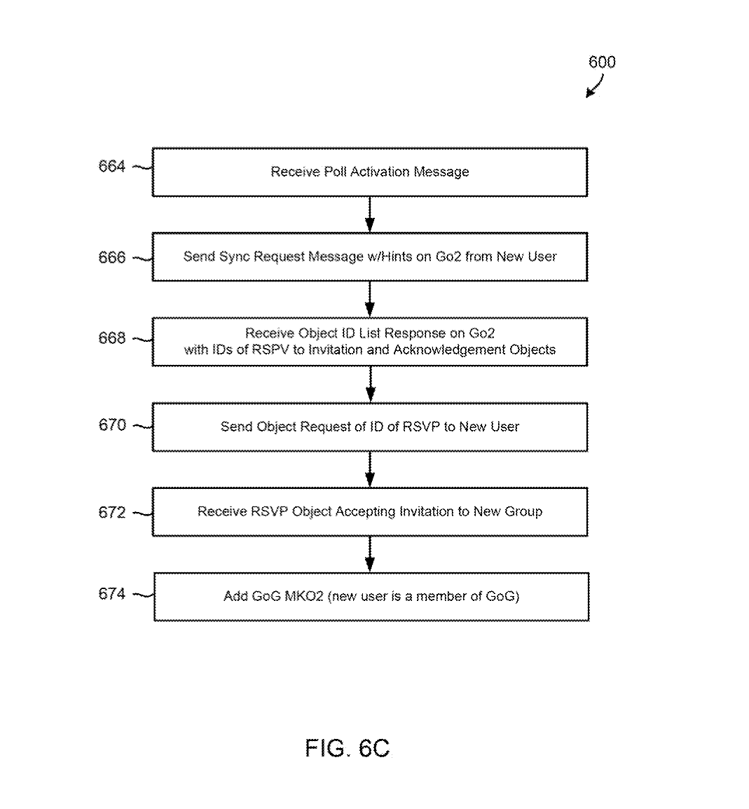

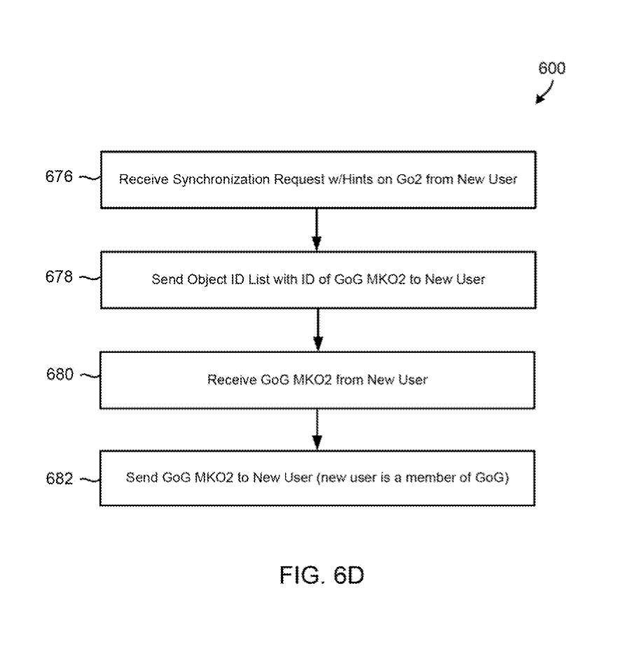

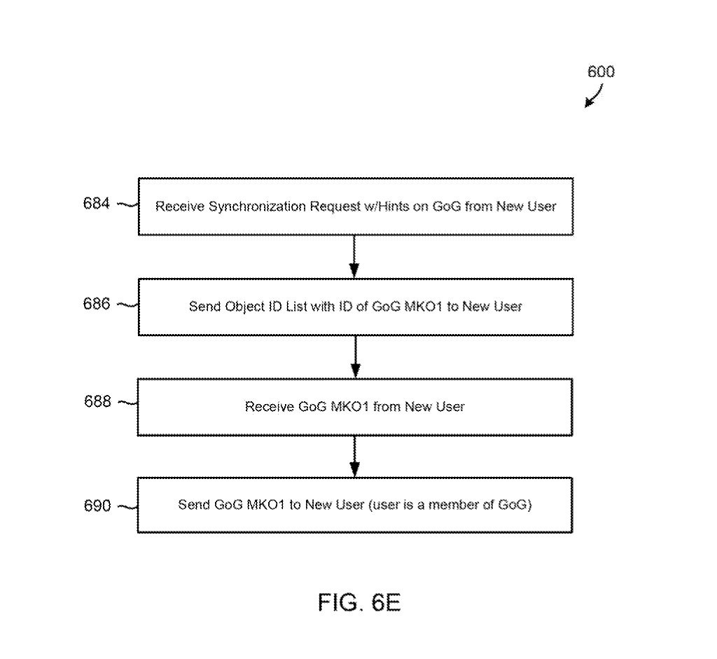

FIGS. 6A through 6E illustrate an embodiment method 600 of adding a new user, client, or device to a collaboration group. The operations of method 600 may be performed by a processing core in a computing device, such as a computing device that includes the client module 204.

In block 602, the processing core may receive request to invite new user/client/device to join a group. This request may include a nickname and an email address. In block 604, the processing core may compute and/or encode a hash of the new user's email address. In block 606, the processing core may query the DNS for a pointer record (PTR) via the hash. For example, the processing core may generate and send a DNS query message that includes the computed hash to the DNS recursive resolver module 308 in block 606. In block 608, the processing core may receive an e(N) value in a DNS response message that is sent in response to the DNS query message.

In block 610, the processing core may query the DNS for the text record (TXT) for the new user's e(N) value. In block 612, the processing core may receive new user's SID value from a corresponding DNS response message.

In block 614, the processing core may query the DNS for the pointer record (PTR) for the new user's SID. In block 616, the processing core may receive the new user's i(N) value from a corresponding DNS response message.

In block 618, the processing core may query the DNS for the text record (TXT) for the new user's i(N) value. In block 620, the processing core may receive a public key from a corresponding DNS response message.

In block 622, the processing core may query the DNS for the pointer record (PTS) for the new user's SID. In block 624, the processing core may receive a g(N) from a corresponding DNS response message.

In block 626, the processing core may query the DNS for the service record (SRV) for the new user's g(N). In block 628, the processing core may receive new user's relay IP, port, and data level from a corresponding DNS response message.

With reference to FIG. 6B, in block 630, the processing core may create communication group-of-two (Go2), set its group ID (GID) as the user SID or new user SID. In block 632, the processing core may create/insert the group-of-two (Go2) in the database. In block 634, the processing core may add a Go2 MKO1 to the database (user is a member of group).

In block 636, the processing core may publish the group-of-two (Go2) to the relay (e.g., relay DNS module 310) for the user. In block 638, the processing core may send a Go2 CRIM Invitation object to the new user/device/module. In block 642, the processing core may receive an RSVP CRIM response message from the new user. In block 644, the processing core may add a Go2 MKO2 to the database (new user is a member of group).

In block 646, the processing core may send a Go2 MKO2 to new user as a CRIM message. In block 648, the processing core may receive an object ID list request message from the new user device. In block 650, the processing core may send IDS of two (2) MKO's for the group-of-two (Go2), and an invitation for new group. In block 652, the processing core may receive object request message for first Go2 MKO 1. In block 654, the processing core may send the Go2 MKO1 (user is member of go2). In block 656, the processing core may receive an object request message for the second group MKO (Go2 MKO2). In block 658, the processing core may send Go2 MKO2 (new user is member of Go2). In block 660, the processing core may receive an object request message for an invitation to join the new group. In block 662, the processing core may send a group invitation message.

With reference to FIG. 6C, in block 664, the processing core may receive a poll activation message. In block 666, the processing core may send synchronize request message and a hints list on Go2 from new user/device/module. In block 668, the processing core may receive an object ID list response message via the group-of-two (Go2), with IDs of an RSVP to an invitation and acknowledgement objects. In block 670, the processing core may send an object request for the ID of the RSVP to the new user/device/module. In block 672, the processing core may receive an RSVP object accepting the invitation to join the new group. In block 674, the processing core may add a GoG MKO2 (new user is a member of GoG).

With reference to FIG. 6D, in block 676, the processing core may receive a synchronization request that includes a hints list via the group-of-two (Go2) from the new user/device/module. In block 678, the processing core may send an object ID list with an ID of the GoG MKO2 to the new user/device/module. In block 680, the processing core may receive a GoG MKO2 from new user/device/module. In block 682, the processing core may send a GoG MKO2 to the new user/device/module (new user is a member of GoG).

With reference to FIG. 6E, in block 684, the processing core may receive a synchronization request that includes a hints list on GoG from the new user/device/module. In block 686, the processing core may send object ID list with an ID of GoG MKO1 to the new user/device/module. In block 688, the processing core may receive GoG MKO1 from new user/device/module. In block 690, the processing core may send user/device/module to the new user/device/module (user is a member of GoG).

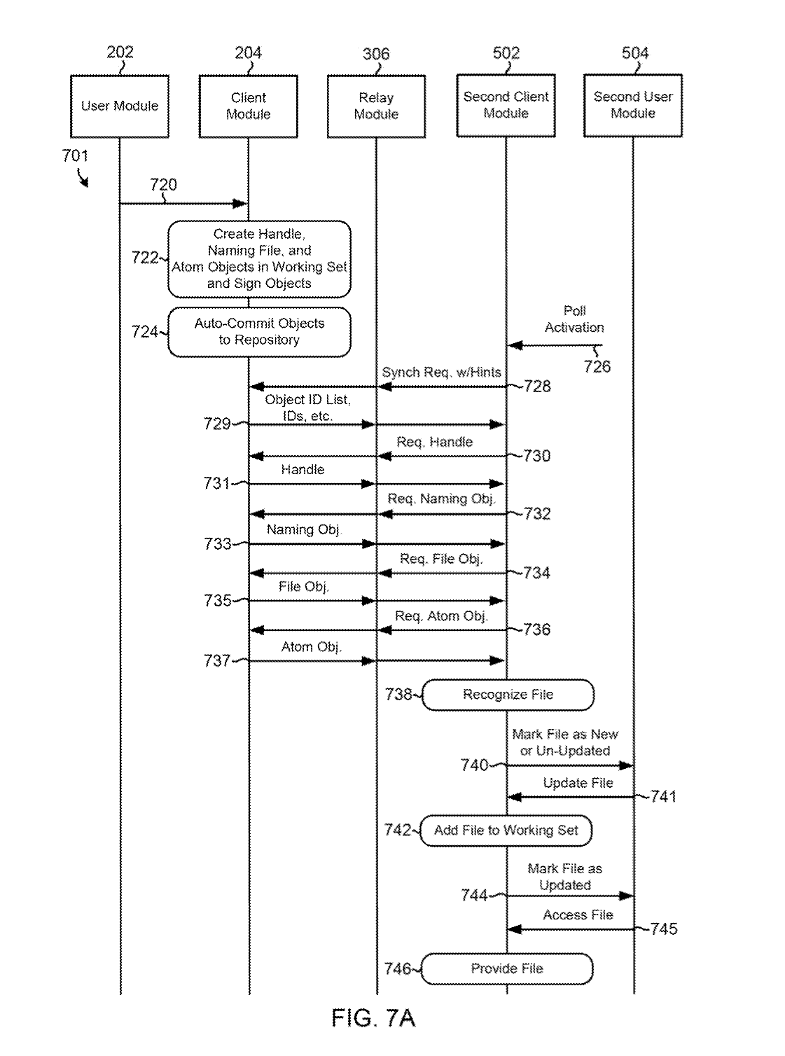

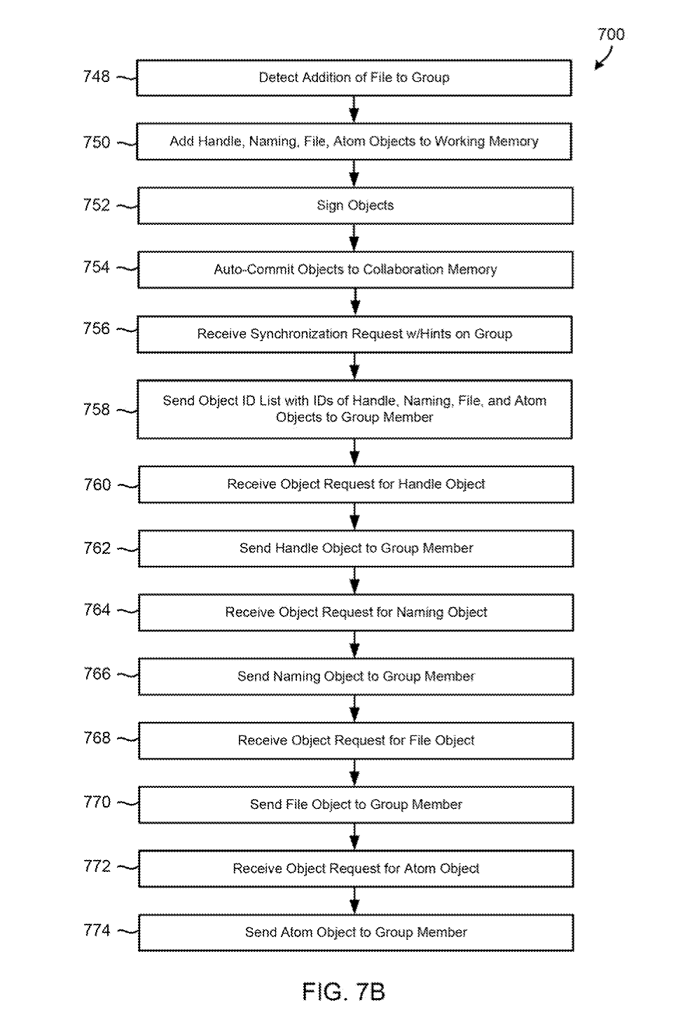

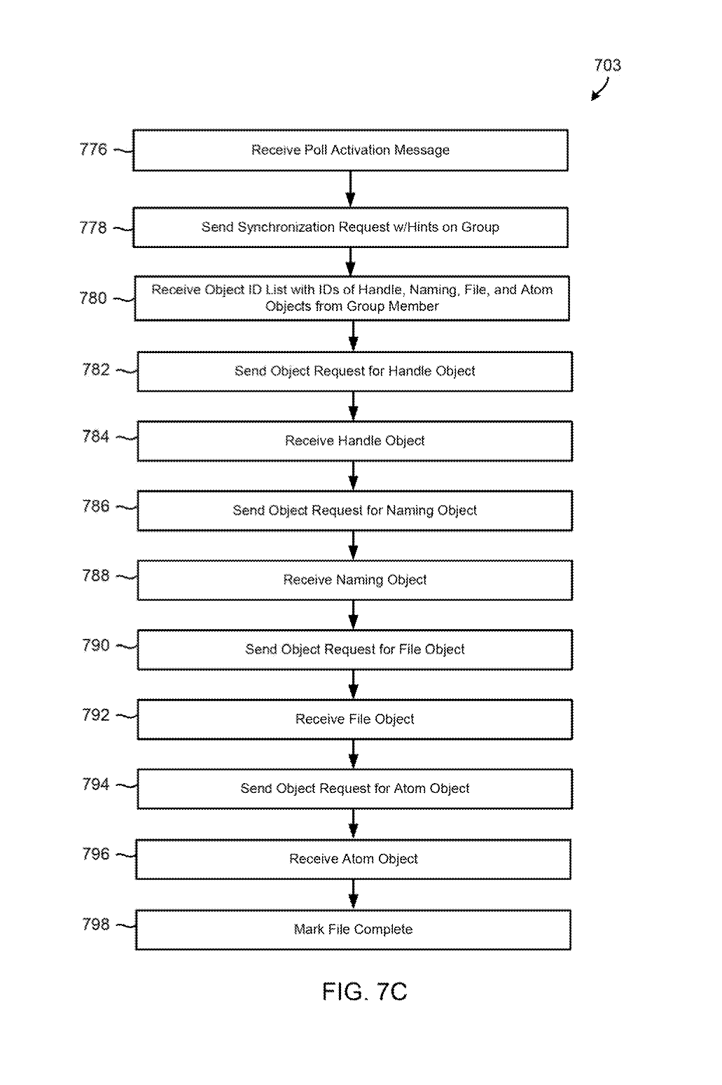

FIG. 7A illustrates various components, operations, and information flows in a data replication system configured to perform a method 701 of synchronizing a document between computing devices in a collaboration group. The operations of method 701 may be performed by one or more processing cores in one or more computing devices.

In operation 720, the user module 202 may add a document to a collaboration group. In operation block 722, the client module 204 may create a handle for the document, name the document, generate objects to include the document and metadata, and generate signatures for generated objects. In an embodiment, the client module 204 may store the objects and signatures in a “working set” portion of its memory. The working set portion of the memory may include documents and information that are not shared with other members of the collaboration group.

In operation block 724, the client module 204 may save, store, transfer, commit, or auto-commit the objects to a local or remote repository, such as a local collaboration memory. That is, the repository may be a memory (or portion of memory) that is shared with other computing devices in the collaboration group.

In operation 726, the second client module 502 may receive a poll activation message. In operation 728, the second client module 502 may send a synchronization request with a hints list to client module 204, either directly or via the relay module 306. In operation 729, the client module 204 may send an object ID list and identifiers for handle, naming, file, and atom objects to the second client module 502.

In operation 730, the second client module 502 may send a handle request message to the client module 204 to request a handle object. In operation 731, the client module 204 may send the requested handle object to the second client module 502. In operation 732, the second client module 502 may send a naming object request message to the client module 204 to request a naming object. In operation 733, the client module 204 may send the request naming object to the second client module 502. In operation 734, the second client module 502 may send a file request message to the client module 204 to request file objects. In operation 735, the client module 204 may send the requested file objects to the second client module 502. In operation 736, the second client module 502 may send an atom request message to the client module 204 to request atom objects. In operation 737, the client module 204 may send the requested atom objects to the second client module 502.

In operation block 738, the second client module 502 may recognize the file. In operation 740, the second client module 502 may mark the recognized file as a new or un-updated file and communicate this information to the second user module 504. In operation 741, the second user module may receive file updates from the user, and communicate the updated file to the second client module 502.

In operation block 742, the second client module 502 may add the file to it working set, such as by storing the file in the local working memory. In operation 744, the second client module 502 may mark the file as updated, and communicate this information to the second user module 504. In operation 745, the second user module 504 may request to access the file. In operation block 746, the second client module 502 may make the file available for access and use by the user.

FIG. 7B illustrates an embodiment method 700 sharing a document with another member of its collaboration group. The operations of method 700 may be performed by a processing core in a computing device, such as a computing device that includes the client module 204.

In block 748, the processing core may detect the addition or sharing of a file with the collaboration group. In block 750, the processing core may add handle, naming, file and atom objects to the working memory. In block 752, the processing core may sign all the objects. In block 754, the processing core may transfer, save, commit, or auto-commit the objects to the collaboration memory.

In block 756, the processing core may receive a synchronization request message that includes a hints list. In block 758, the processing core may send an object ID list and IDs of the handle, naming, file, and atom objects to another user/device/module that is a member of the collaboration group.

In block 760, the processing core may receive an object request message requesting the handle object. In block 762, the processing core may send the handle object to the other user/device/module in the collaboration group. In block 764, the processing core may receive an object request message requesting the naming object. In block 766, the processing core may send the naming object to the other user/device/module in the collaboration group. In block 768, the processing core may receive an object request message requesting the file object. In block 770, the processing core may send the file object to the other user/device/module in the collaboration group. In block 772, the processing core may receive an object request message requesting the atom object. In block 774, the processing core may send the atom object to the other user/device/module in the collaboration group.

FIG. 7C illustrates an embodiment method 703 of receiving a document from another member of the collaboration group. The operations of method 700 may be performed by a processing core in a computing device, such as a computing device that includes the client module 204.

In block 776, the processing core may receive a poll activation message. In block 778, the processing core may send a synchronization request message that includes a hints list to another user/device/module in the collaboration group. In block 780, the processing core may receive an object ID list, and IDs for handle, naming, file, and atom objects. In block 782, the processing core may send an object request message to request the handle object. In block 784, the processing core may receive the handle object. In block 786, the processing core may send an object request message requesting the naming object. In block 788, the processing core may receive the naming object. In block 790, the processing core may send an object request message requesting the file object. In block 792, the processing core may receive the file object. In block 794, the processing core may send an object request message requesting the atom object. In block 796, the processing core may receive the atom object. In block 798, the processing core may mark the file as complete.

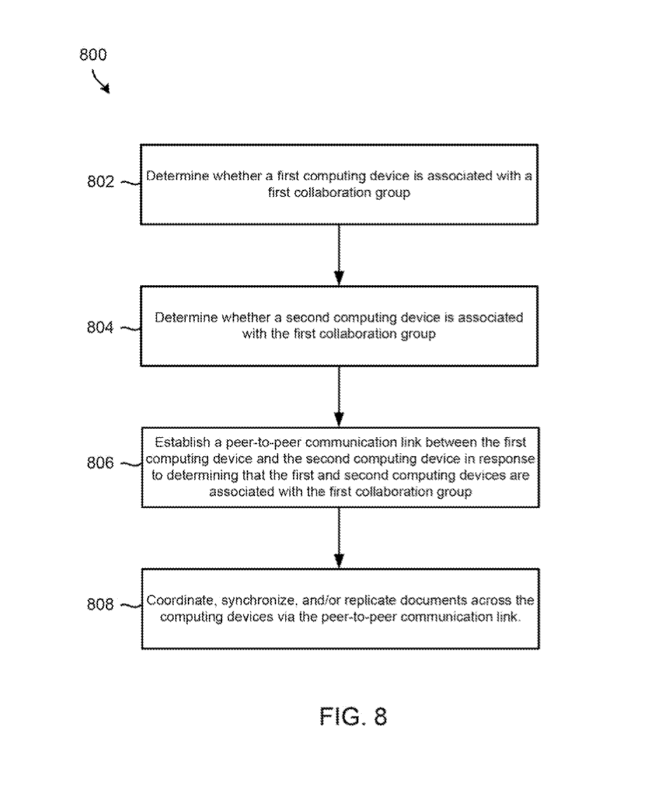

FIG. 8 illustrates an embodiment method 800 of establishing communication links and synchronizing documents based on group membership in accordance with an embodiment. Method 800 may be performed in a processing core of a computing device.

In block 802, a processing core of a first computing device may determine whether the first computing device is associated with a collaboration group. In block 804, the processing core may determine whether a second computing device is associated with that same collaboration group. In block 806, the processing core may perform various operations to establish a peer-to-peer communication link to the second computing device in response to determining that the first and second computing devices are associated with the same collaboration group. In block 808, the processing core may coordinate, synchronize, and/or replicate documents across the computing devices via the peer-to-peer communication link. In an embodiment, this may be accomplished by storing the documents in a local collaboration memory of the computing device, and synchronizing this memory.

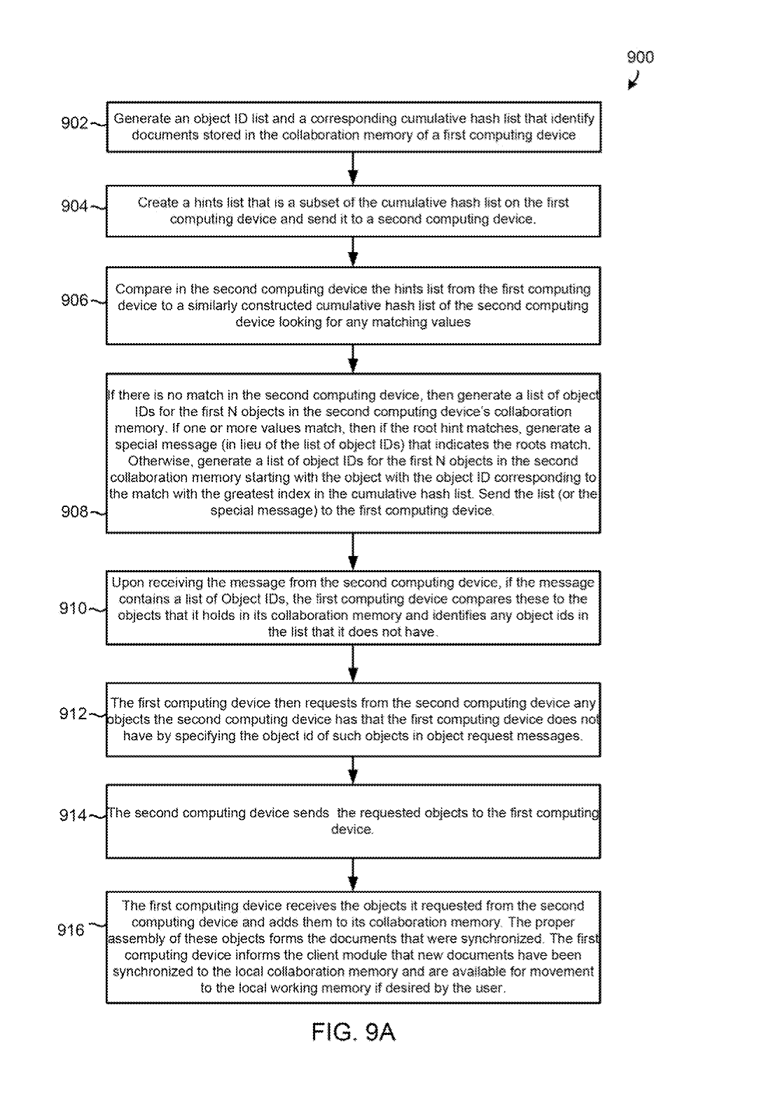

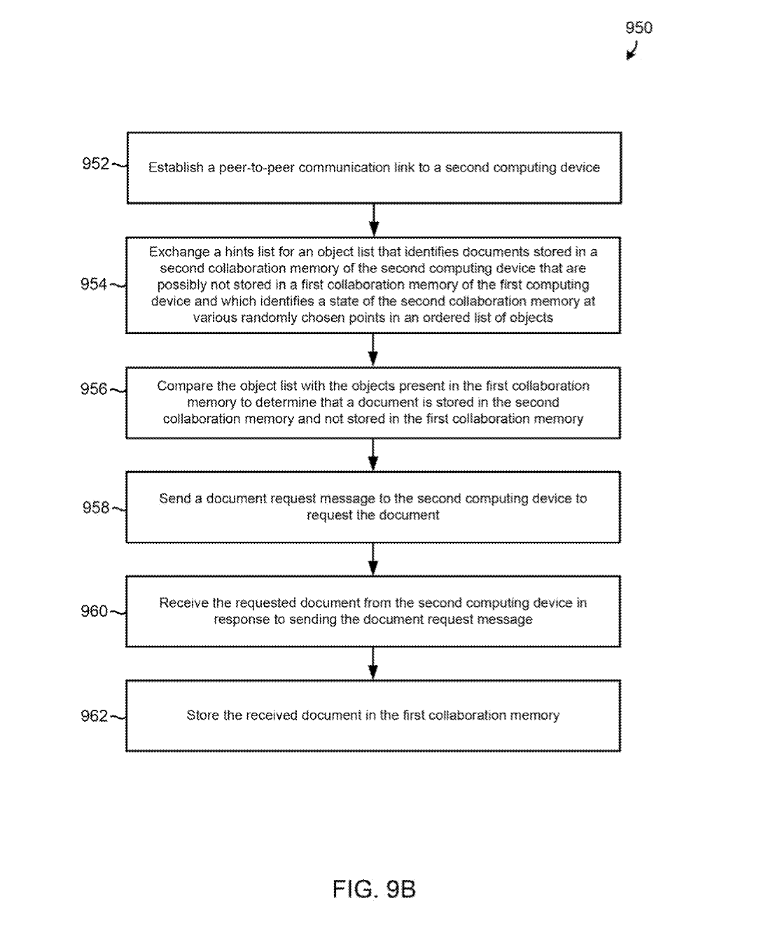

FIG. 9A illustrates an embodiment method 900 of synchronizing documents in accordance with an embodiment. Method 900 may be performed in processing cores of a first and second computing device.

In block 902, a processing core of a first computing device may generate an ordered object ID list and a corresponding cumulative hash list that identify objects (and hence, ultimately, documents) stored in a first collaboration memory of the first computing device. As discussed above, the object ID list may be an ordered list of the Object IDs of each object stored in the local collaboration memory. The cumulative hash list may be a list of hash values that includes a record for each record included in the object ID list. Each of the hash values may be computed as a hash of a corresponding object ID (i.e., having same index or location in the list) and all preceding object IDs in the object ID list. For example, the first entry in the cumulative hash list may be a hash of the first entry in the object ID list; the second entry in the cumulative hash list may be a hash of the first and second entries in the object ID list; the third entry in the cumulative hash list may be a hash of the first, second, and third entries in the object ID list; and so on.

In an embodiment, in block 904, the first processing core may create a hints list by selecting a small number of entries from the cumulative hash list, either randomly or according to a heuristic scheme. The selection process may include the selection of the most cumulative hash value from the cumulative hash list and this value may be identified as the root hint. The hints list may not exceed the cumulative hash list in number. The hints list may number as few as zero entries if the cumulative hash list is empty. The hints list may number more entries as the cumulative hash list grows larger. However, the hints list preferably does not equal more than a small percentage of the number of the cumulative hash list. The first processing core may then send the hints list to the second computing device.

In an embodiment, in block 906, the second computing device may then compare the hints list received from the first computing device to the local cumulative hash list created over the object IDs of the objects that the second computing device holds in local collaborative memory looking for cumulative hash values in the hints list that match cumulative hash values in the cumulative hash list. There may be no match, or one or more hash values in the hints list may match hash values in the cumulative hash list.

In an embodiment, in block 908, if there is no match, then the first object in the collaboration memory of the first computing device differs from the first object in the collaboration memory of the second computing device. The second computing device may generate a list of the first N (where N may be on the order of up to 1,000) object IDs that may be contained in the second collaboration memory and may send that object ID list to the first computing device.

Also, in an embodiment, in block 908, if one or more hash values in the hints list match some hash values in the cumulative hash list, then the match that has the largest index into the cumulative hash list of the second computing device may be chosen. If the root hint in the hints list from the first computing device matches the hash value with the largest index (e.g., the last value) in the cumulative hash list from the second computing device, then the cumulative hash list of the second computing device matches the cumulative hash list of the first computing device, the object IDs of the objects in the first collaboration memory match the object IDs of the objects in the second collaboration memory, the collaboration memories of the two computing devices contain the same set of objects and the two collaboration memories may be said to match. In this case, the second computing device may generate a message (in lieu of a list of object IDs) that indicates that the roots match. Otherwise, the second computing device may generate a list of up to N (where N may be on the order of up to 1,000) object IDs starting from the object ID that corresponds to the hash value in the cumulative hash list that has the largest index and may send that list to the first computing device.

In an embodiment, in block 910, the processing core of the first computing device may receive an indication that the roots match. In this case, the computing devices may cease further processing to synchronize their documents/objects as the collaboration memories of the two computing devices are equal.

Alternatively, in an embodiment, in block 910, the processing core of the first computing device may compare the received object ID list with the object IDs of objects present in the local collaboration memory of the first computing device to determine that a document (or one or more of its constituent objects) is stored in the second collaboration memory and not stored in the first collaboration memory.

In an embodiment, in block 912, the first computing device may request from the second computing device any objects identified above that the second computing device has that the first computing device does not have by specifying the object id of such objects in a series of object request messages.

In an embodiment, in block 914, the second computing device may send the requested objects to the first computing device.

In an embodiment, in block 916 the first computing device may receive the objects it requested from the second computing device and add them to its collaboration memory. The proper assembly of these objects may form the documents that were synchronized. Also in block 916, the first computing device may inform the client module that new documents have been synchronized to the local collaboration memory and are available for movement to the local working memory if desired by the user.

In a further embodiment, the processing core may be configured to receive a document request message from a third computing device, retrieve the signed and encrypted objects from the first collaboration memory, and forward the retrieved signed and encrypted object to the third computing device.

FIG. 9B illustrates a method 950 of synchronizing documents in accordance with another embodiment. Method 950 may be performed in one or more processing cores of one or more computing devices.

In block 952, a first computing device may establish a peer-to-peer communication link to a second computing device. In an embodiment, the first computing device may establish the peer-to-peer communication link in response to determining that the first and second computing devices are associated with the same collaboration group. In block 954, the first computing device may exchange a hints list for an object list that identifies documents stored in a second collaboration memory of the second computing device that are possibly not stored in a first collaboration memory of the first computing device and which identifies a state of the second collaboration memory at various randomly chosen points in an ordered list of objects. Exchange a hints list for an object list may include sending the hints list to the second computing device, and in response, receiving the objects list.

In block 956, the first computing device may compare the object list with the objects present in the first collaboration memory to determine that a document is stored in the second collaboration memory and not stored in the first collaboration memory. In block 958, the first computing device may send a document request message to the second computing device to request the document determined to be stored in the second collaboration memory and not the first collaboration memory. In block 960, the first computing device may receive the requested document from the second computing device in response to sending the document request message. In block 962, the first computing device may store the received document in the first collaboration memory.

Further embodiments include methods, and computing devices configured to implement the methods, of communicating documents in a communication system that includes a plurality of computing devices, which may include determining in a processor of a first computing device whether the first computing device is associated with a first collaboration group, determining in the processor whether a second computing device is associated with the first collaboration group, establishing a peer-to-peer communication link between the first computing device and the second computing device in response to determining that the first and second computing devices are associated with the first collaboration group, generating in the processor a local cumulative hash list that identifies documents stored in a first collaboration memory of the first computing device, receiving a hints list that identifies documents stored in a second collaboration memory of the second computing device, comparing the received hints list with the local cumulative hash list to determine that a document is stored in the second collaboration memory and not stored in the first collaboration memory, sending a document request message to the second computing device to request the document, receiving the requested document from the second computing device in response to sending the document request message, and storing the received document in the first collaboration memory.

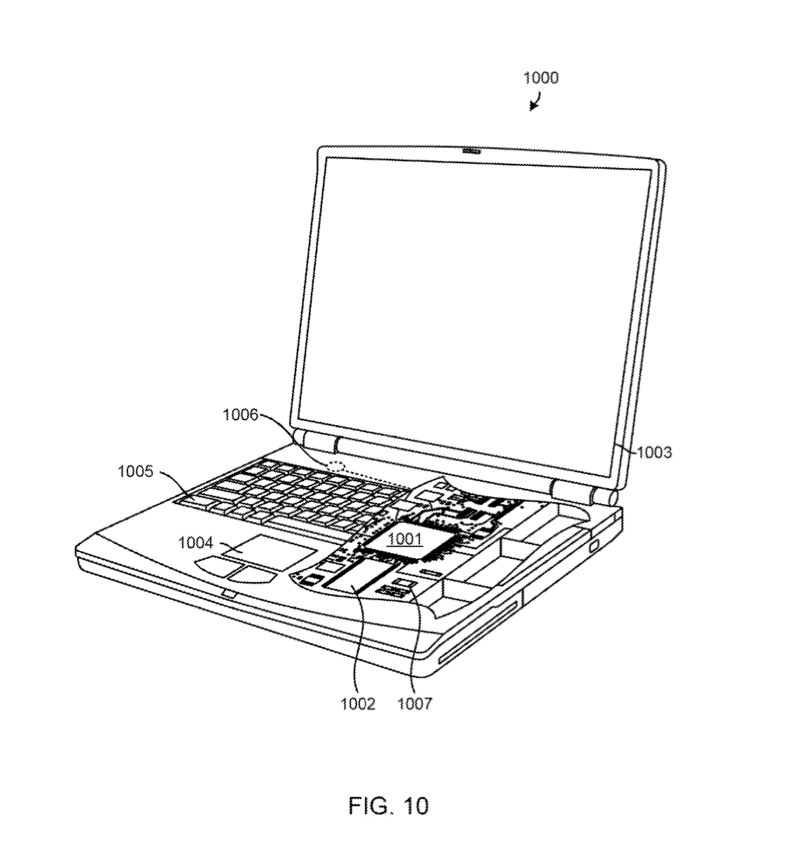

In an embodiment, receiving the requested document from the second computing device may include receiving the requested document from a dark storage device. In a further embodiment, receiving the requested document from the second computing device may include receiving a plurality of signed and encrypted objects from the second computing device, and storing the received document in the first collaboration memory may include storing the signed and encrypted objects in the first collaboration memory. In a further embodiment, the method may include receiving in the processor a second document request message from a third computing device, retrieving the signed and encrypted object from the first collaboration memory, and forwarding the retrieved signed and encrypted object to the third computing device. In a further embodiment, comparing the received hints list with the local cumulative hash list may include comparing a first hash of one or more object identifiers with a second hash of one or more object identifiers. In a further embodiment, comparing the received hints list with the local cumulative hash list includes comparing a most-cumulative hash value included in the received hints list with a second hash value included in the local cumulative hash list. The various embodiments may be implemented on a variety of computing devices, an example of which is illustrated in FIG. 10 in the form of a laptop. The laptop 1000 may include a processor 1001 coupled to internal memory 1002 and an electronic display 1003. Additionally, the laptop 1000 may include a mouse pad 1004 and keyboard 1005 for receiving user inputs that are coupled to the processor 1001. The laptop 1000 may also include network access ports 1006 coupled to the processor 1001 for establishing data connections with a network, such as a local area network coupled to other broadcast system computers and servers. The laptop 1000 may further include an ANT, ANT+, or ZigBee (i.e., an IEEE 802.15.4) transceiver 1007 for low-power short-range communications and other similar communication circuitry (e.g., circuitry implementing the Bluetooth® or WiFi protocols, etc.).

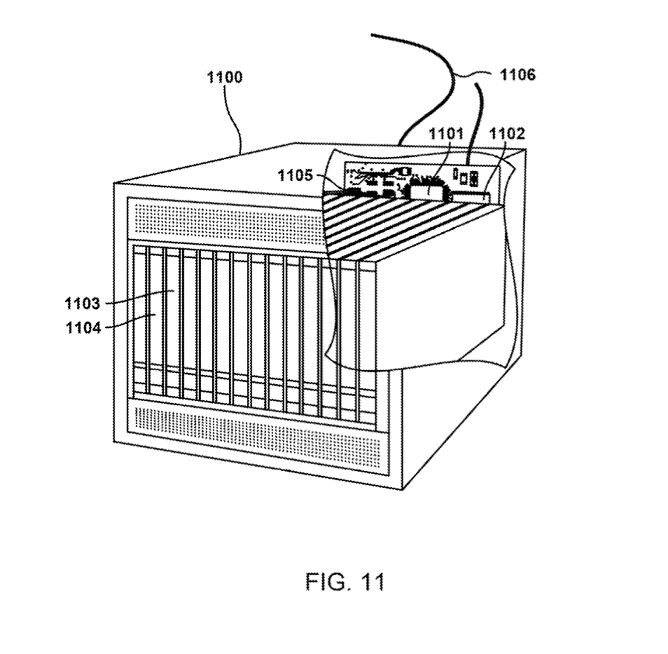

Various embodiments may be implemented on any of a variety of commercially available server devices, such as the server 1100 illustrated in FIG. 11. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1104 coupled to the processor 1101. The server 1100 may also include network access ports 1105 coupled to the processor 1101 for establishing data connections with a network 1106, such as a local area network coupled to other servers.

The processors 1001, 1101 may be any programmable microprocessor, microcomputer or multiple processor chip or chips that can be configured by software instructions (applications) to perform a variety of functions, including the functions of the various embodiments described below. In some computing devices, multiple processors 1001, 1101 may be provided, such as one processor dedicated to wireless communication functions and one processor dedicated to running other applications. Typically, software applications may be stored in the internal memory 1002, 1102, 1103 before they are accessed and loaded into the processor 1001, 1101. The processor 1001, 1101 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of communicating documents in a communication system that includes a plurality of computing devices, the method comprising:
determining in a processor of a first computing device whether the first computing device is associated with a first collaboration group;
determining in the processor whether a second computing device is associated with the first collaboration group;
establishing a peer-to-peer communication link between the first computing device and the second computing device in response to determining that the first and second computing devices are associated with the first collaboration group;
exchanging a hints list for an object list that identifies documents stored in a second collaboration memory of the second computing device that are possibly not stored in a first collaboration memory of the first computing device and which identifies a state of the second collaboration memory at various randomly chosen points in an ordered list of objects;
comparing the object list with the objects present in the first collaboration memory to determine that a document is stored in the second collaboration memory and not stored in the first collaboration memory;
sending a document request message to the second computing device to request the document;
receiving the requested document from the second computing device in response to sending the document request message; and
storing the received document in the first collaboration memory.

2. The method of claim 1, wherein receiving the requested document from the second computing device comprises receiving the requested document from a dark storage device.

3. The method of claim 1, wherein:
receiving the requested document from the second computing device comprises receiving a plurality of signed and encrypted objects from the second computing device; and
storing the received document in the first collaboration memory comprises storing the signed and encrypted objects in the first collaboration memory.

4. The method of claim 3, further comprising:
receiving in the processor a second document request message from a third computing device;
retrieving the signed and encrypted object from the first collaboration memory; and
forwarding the retrieved signed and encrypted object to the third computing device.

5. The method of claim 1, wherein comparing the object list with the objects present in the first collaboration memory comprises comparing a first hash of one or more object identifiers with a second hash of one or more object identifiers.

6. The method of claim 1, wherein comparing the object list with the objects present in the first collaboration memory comprises comparing a most-cumulative hash value included in the object list with a second hash value.

7. A computing device, comprising:
a first collaboration memory;
a processor coupled to the first collaboration memory, wherein the processor is configured with processor-executable instructions to perform operations comprising:
determining whether the computing device is associated with a first collaboration group;
determining whether a second computing device is associated with the first collaboration group;
establishing a peer-to-peer communication link to the second computing device in response to determining that the computing device and the second computing device are both associated with the first collaboration group;
exchanging a hints list for an object list that identifies documents stored in a second collaboration memory of the second computing device that are possibly not stored in the first collaboration memory and which identifies a state of the second collaboration memory at various randomly chosen points in an ordered list of objects;
comparing the object list with the objects present in the first collaboration memory to determine that a document is stored in the second collaboration memory and not stored in the first collaboration memory;
sending a document request message to the second computing device to request the document;
receiving the requested document from the second computing device in response to sending the document request message; and
storing the received document in the first collaboration memory.

8. The computing device of claim 7, wherein the processor is configured with processor-executable instructions to perform operations such that receiving the requested document from the second computing device comprises receiving the requested document from a dark storage device.

9. The computing device of claim 7, wherein the processor is configured with processor-executable instructions to perform operations such that:
receiving the requested document from the second computing device comprises receiving a plurality of signed and encrypted objects from the second computing device; and
storing the received document in the first collaboration memory comprises storing the signed and encrypted objects in the first collaboration memory.

10. The computing device of claim 9, wherein the processor is configured with processor-executable instructions to perform operations further comprising:
receiving a second document request message from a third computing device;
retrieving the signed and encrypted object from the first collaboration memory; and
forwarding the retrieved signed and encrypted object to the third computing device.

11. The computing device of claim 7, wherein the processor is configured with processor-executable instructions to perform operations such that comparing the object list with the objects present in the first collaboration memory comprises comparing a first hash of one or more object identifiers with a second hash of one or more object identifiers.

12. The computing device of claim 7, wherein the processor is configured with processor-executable instructions to perform operations such that comparing the object list with the objects present in the first collaboration memory comprises comparing a most-cumulative hash value included in the object list with a second hash value.

13. A computing device, comprising:
means for determining whether the computing device is associated with a first collaboration group;
means for determining whether a second computing device is associated with the first collaboration group;
means for establishing a peer-to-peer communication link to the second computing device in response to determining that the computing device and the second computing device are both associated with the first collaboration group;
means for exchanging a hints list for an object list that identifies documents stored in a second collaboration memory of the second computing device that are possibly not stored in a first collaboration memory and which identifies a state of the second collaboration memory at various randomly chosen points in an ordered list of objects;
means for comparing the object list with the objects present in the first collaboration memory to determine that a document is stored in the second collaboration memory and not stored in the first collaboration memory;
means for sending a document request message to the second computing device to request the document;
means for receiving the requested document from the second computing device in response to sending the document request message; and
means for storing the received document in the first collaboration memory.

14. The computing device of claim 13, wherein means for receiving the requested document from the second computing device comprises means for receiving the requested document from a dark storage device.

15. The computing device of claim 13, wherein:
means for receiving the requested document from the second computing device comprises means for receiving a plurality of signed and encrypted objects from the second computing device; and
means for storing the received document in the first collaboration memory comprises means for storing the signed and encrypted objects in the first collaboration memory.

16. The computing device of claim 15, further comprising:
means for receiving a second document request message from a third computing device;
means for retrieving the signed and encrypted object from the first collaboration memory; and
means for forwarding the retrieved signed and encrypted object to the third computing device.

17. The computing device of claim 13, wherein means for comparing the object list with the objects present in the first collaboration memory comprises means for comparing a first hash of one or more object identifiers with a second hash of one or more object identifiers.

18. The computing device of claim 13, wherein means for comparing the object list with the objects present in the first collaboration memory comprises means for comparing a most-cumulative hash value included in the object list with a second hash value.

19. A non-transitory computer readable storage medium having stored thereon processor-executable software instructions configured to cause a processor of a computing device to perform operations for communicating documents in a communication system that includes a plurality of computing devices, the operations comprising:
determining whether the computing device is associated with a first collaboration group;
determining whether a second computing device is associated with the first collaboration group;
establishing a peer-to-peer communication link between the computing device and the second computing device in response to determining that the computing device and the second computing device are both associated with the first collaboration group;
exchanging a hints list for an object list that identifies documents stored in a second collaboration memory of the second computing device that are possibly not stored in a first collaboration memory and which identifies a state of the second collaboration memory at various randomly chosen points in an ordered list of objects;
comparing the object list with the objects present in the first collaboration memory to determine that a document is stored in the second collaboration memory and not stored in the first collaboration memory;
sending a document request message to the second computing device to request the document;
receiving the requested document from the second computing device in response to sending the document request message; and
storing the received document in the first collaboration memory.

20. The non-transitory computer readable storage medium of claim 19, wherein the stored processor-executable software instructions are configured to cause a processor to perform operations such that receiving the requested document from the second computing device comprises receiving the requested document from a dark storage device.

21. The non-transitory computer readable storage medium of claim 19, wherein the stored processor-executable software instructions are configured to cause a processor to perform operations such that:
receiving the requested document from the second computing device comprises receiving a plurality of signed and encrypted objects from the second computing device; and
storing the received document in the first collaboration memory comprises storing the signed and encrypted objects in the first collaboration memory.

22. The non-transitory computer readable storage medium of claim 21, wherein the stored processor-executable software instructions are configured to cause a processor to perform operations further comprising:
receiving in the processor a second document request message from a third computing device;
retrieving the signed and encrypted object from the first collaboration memory; and
forwarding the retrieved signed and encrypted object to the third computing device.

23. The non-transitory computer readable storage medium of claim 19, wherein the stored processor-executable software instructions are configured to cause a processor to perform operations such that comparing the object list with the objects present in the first collaboration memory comprises comparing a first hash of one or more object identifiers with a second hash of one or more object identifiers.

24. The non-transitory computer readable storage medium of claim 19, wherein the stored processor-executable software instructions are configured to cause a processor to perform operations such that comparing the object list with the objects present in the first collaboration memory comprises comparing a most-cumulative hash value included in the object list with a second hash value.
